(19) United States
(12) Patent Application Publication
(10) Pub. No.: US 2019/0120649 A1
(43) Pub. Date: Apr. 25, 2019

(54) DIALOGUE SYSTEM, VEHICLE INCLUDING THE DIALOGUE SYSTEM, AND ACCIDENT INFORMATION PROCESSING METHOD

(71) Applicants: HYUNDAI MOTOR COMPANY, Seoul (KR); KIA MOTORS CORPORATION, Seoul (KR)

(72) Inventors: Donghee SEOK, Suwon-si (KR); Dongsoo SHIN, Suwon-si (KR); Jeong-Eom LEE, Yongin-si (KR); Ga Hee KIM, Seoul (KR); Seona KIM, Seoul (KR); Jung Mi PARK, Anyang-si (KR); HeeJin RO, Seoul (KR); Kye Yoon KIM, Gunpo-si (KR)

(21) Appl. No.: 15/835,314

(22) Filed: Dec. 7, 2017

(30) Foreign Application Priority Data
Oct. 23, 2017 (KR) 10-2017-0137017

(51) Int. Cl. G01C 21/36

(52) U.S. Cl. CPC G01C 21/3608; G10L 15/265; G01C 21/3629

(57) ABSTRACT

A dialogue system includes an input processor for receiving accident information and extracting an action corresponding to a user's speech, wherein the corresponding action is an action of classifying the accident information by grade, a storage for storing vehicle situation information including the accident information and grades associated with the accident information, a dialogue manager for determining the grade of the accident information on the basis of the vehicle situation information and the user's speech, and a result processor for generating a response associated with the determined grade and delivering the determined grade of the accident information to an accident information processing system.

### CROSS-REFERENCE TO RELATED APPLICATION

This application claims the benefit of priority to Korean Patent Application No. 10-2017-0137017, filed on Oct. 23, 2017 with the Korean Intellectual Property Office, the entire disclosure of which is incorporated herein by reference.

### TECHNICAL FIELD

Embodiments of the present disclosure relate to a dialogue system configured to discover accident information through a dialogue with a user and process information through accurate classification of the accident information, a vehicle including the dialogue system, and an accident information processing method.

### BACKGROUND

Audio/Video/Navigation (AVN) systems for automobiles, and most mobile devices, may have difficulty in providing visual information to a user or receiving the user's input because of their small screens and small buttons.

In particular, the user moving his or her gaze and releasing his or her hand from a steering wheel in order for a user to check visual information or manipulate a device while driving may be a threat to safe driving.

Accordingly, when a dialogue system configured to determine a user's intent through dialogue with the user and to provide a service needed by the user is applied in a vehicle, it is expected to provide more secure and convenient services.

Generally, problems such as car accidents, traffic-calming measures and constructions on roads (hereinafter referred to as “accident information”) are collected and shared through drivers' reports and closed-circuit televisions (CCTVs). Accident information is information that is very important in road traffic situations. A real-time navigation system operates according to such information and is configured to suggest a route change to a user.

Accident information has significant influence on road traffic situations, and thus updating the accident information with accurate information is an important objective. Conventionally, there has been a problem in that feedback on the registration of whether accident information is present and analysis or processing of the accident information is not adequately achieved in real-time.

### SUMMARY

Therefore, it is an aspect of the present disclosure to provide a dialogue system, a vehicle including the same, and an accident information processing method. The dialogue system may specifically determine the presence, deregistration, and severity of accident information, perform real-time updates on a navigation system, and make accurate route guidance and safe driving possible for a driver by acquiring accident information confirmable by a user through dialogue while the vehicle is traveling.

Additional aspects of the disclosure will be set forth in part in the description which follows and, in part, will be obvious from the description, or may be learned by practice of the disclosure.

In accordance with one aspect of the present disclosure, a dialogue system includes an input processor configured to receive accident information and extract an action corresponding to a user's utterance, wherein the corresponding action is an action of classifying the accident information by grade; a storage configured to store vehicle situation information including the accident information and grades associated with the accident information; a dialogue manager configured to determine the grade of the accident information on the basis of the vehicle situation information and the user's utterance; and a result processor configured to generate a response associated with the determined grade and deliver the determined grade of the accident information to an accident information processing system.

The input processor may extract a factor value for determining the grade of the accident information from the user's utterance.

The dialogue manager may determine the grade of the accident information on the basis of a factor value delivered by the input processor and a determination criterion stored by the storage.

The dialogue manager may determine a dialogue policy regarding the determined grade of the accident information, and the result processor may output a response including the classification grade of the accident information.

When the input processor does not extract the factor value for determining the grade of the accident information, the dialogue manager may acquire the factor value from the storage.

The factor value may include at least one of an accident time, a traffic flow, a degree to which an accident vehicle is damaged, and the number of accident vehicles.

The result processor may generate a point acquisition response based on of the determined classification grade of the accident information.

The dialogue manager may change the classification grade over time and store the changed grade in the storage.

In accordance with another aspect of the present disclosure, a vehicle includes an audio-video-navigation (AVN) device configured to set a driving route and execute navigation guidance on the basis of the driving route; an input processor configured to receive accident information from the AVN device and extract an action corresponding to a user's utterance wherein the corresponding action is an action of classifying the accident information by grade; a storage configured to store vehicle situation information including the accident information and grades associated with the accident information; a dialogue manager configured to determine the grade of the accident information on the basis of the vehicle situation information and the user's utterance; and a result processor configured to generate a response associated with the determined grade and deliver the determined grade of the accident information to the AVN device.

The AVN device may execute the navigation guidance on the basis of the determined grade of the accident information delivered from the result processor.

The vehicle may further include a communication device configured to communicate with an external server, wherein the communication device may receive the accident information and deliver the accident information to at least one of the AVN device and the external server.

The input processor may extract a factor value for determining the grade of the accident information from the user's utterance.

The dialogue manager may determine the grade of the accident information on the basis of a factor value delivered by the input processor and a determination criterion stored by the storage.

When the accident information is pre-reported accident information, the dialogue manager may request that the accident information be maintained through the communication device.

The dialogue manager may deliver the determined grade reliability of the accident information and reliability of the accident information to an external source through the communication device.

The vehicle may further include a camera configured to capture the user and an outside of the vehicle, wherein when a factor value necessary to determine the grade of the accident information is not extracted, the dialogue manager may extract the factor value of the action factor on the basis of situation information acquired by the camera.

In accordance with still another aspect of the present disclosure, a method of classifying accident information by grade includes receiving the accident information and extracting an action corresponding to a user's utterance, wherein the corresponding action is an action of classifying the accident information by grade; storing an information value of vehicle situation information including the accident information and grades associated with the accident information; determining the grade of the accident information on the basis of the stored information value of the vehicle situation information and the user's utterance; generating a response associated with the determined grade; and delivering the determined grade of the accident information to an accident information processing system.

The extraction may include extracting a factor value for determining the grade of the accident information from the user's utterance.

The determination may include determining a dialogue policy regarding the grade of the accident information.

The method may further include receiving the information value of the vehicle situation information from a mobile device connected to the vehicle; and transmitting the response to the mobile device.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram of a dialogue system and an accident information processing system according to exemplary embodiments of the present disclosure;

FIG. 2 is a view showing an internal configuration of a vehicle according to exemplary embodiments of the present disclosure;

FIGS. 3 to 5 are views showing example dialogues that may be conducted between a dialogue system and a driver according to exemplary embodiments of the present disclosure;

FIG. 6A is a control block diagram for a standalone method in which a dialogue system and an accident information processing system are provided in a vehicle according to exemplary embodiments of the present disclosure;

FIG. 6B is a control block diagram for a vehicular gateway method in which a dialogue system and an accident information processing system are provided in a remote server and a vehicle serves only as a gateway for making connection to the systems according to exemplary embodiments of the present disclosure;

FIGS. 7 and 8 are detailed control block diagrams showing an input processor among the elements of the dialogue system according to exemplary embodiments of the present disclosure;

FIGS. 9A and 9B are views showing example information stored in a situation understanding table according to exemplary embodiments of the present disclosure;

FIG. 10 is a detailed control block diagram of a dialogue manager according to exemplary embodiments of the present disclosure;

FIG. 11 is a detailed control block diagram of a result processor according to exemplary embodiments of the present disclosure;

FIG. 12 is a diagram illustrating classification by grade for accident information output by a dialogue system according to exemplary embodiments of the present disclosure;

FIGS. 13 to 15 are diagrams illustrating a detailed example of recognizing a user's speech and classifying accident information as shown in FIG. 12; and

FIG. 16 is a flowchart showing a method of classifying accident information by grade performed by a vehicle including a dialogue system according to exemplary embodiments of the present disclosure.

### DETAILED DESCRIPTION

Like reference numerals refer to like elements throughout. This disclosure does not describe all elements of embodiments, and a general description in a technical field to which the present disclosure belongs or a repetitive description in the embodiments will be omitted. As used herein, “unit,” “module,” “member,” or “block” may be implemented in software or hardware. Depending on embodiments, a plurality “units,” “modules,” “members,” or “blocks” may be implemented as one element, or one “unit,” “module,” “member,” or “block” may include a plurality of elements.

In this disclosure below, when one part is referred to as being “connected” to another part, it should be understood that the former can be “directly connected” to the latter, or “indirectly connected” via a wireless communication network.

Furthermore, when one part is referred to as “comprising” (or “including” or “having”) other elements, it should be understood that the part can comprise (or include or have) only those elements or other elements as well as those elements unless specifically described otherwise.

The singular forms “a,” “an,” and “the” are intended to include the plural forms as well, unless the context clearly indicates otherwise.

The reference numerals attached to the respective steps are used to identify each step, and these reference numerals do not denote the order of the steps. Each step may be performed differently from the sequence specified unless explicitly stated in the context of the particular sequence.

Hereinafter, a dialogue system, a vehicle including the same, and an accident information processing method will be described in detail with reference to the accompanying drawings.

A dialogue system according to exemplary embodiments is an apparatus configured to determine a user's intent by means of the user's voice and the user's inputs other than voice and to provide a service appropriate to the user's intent or a service needed by the user. Also, the dialogue system may perform a dialogue with the user by outputting a system's utterances in order to provide a service or clarify a user's intent.

In these embodiments, the service provided to the user may include all operations performed to meet the user's need or intent such as provision of information, control of a vehicle, execution of audio/video/navigation functions, provision of content from an external server, etc.

Also, the dialogue system according to exemplary embodiments may accurately discover a user's intent in special environments such as a vehicle by providing dialogue processing technology specialized for vehicular environments.

A vehicle or a mobile device connected to a vehicle may serve as a gateway that connects the dialogue system and a user. In the following description, the dialogue system may be provided in a vehicle or may be provided in a remote server outside a vehicle to transmit and receive data through communication with the vehicle or the mobile device connected to the vehicle.

Also, some elements of the dialogue system may be provided in a vehicle and the other elements of the dialogue system may be provided in a remote server. Thus, the vehicle and the remote server may cooperatively perform operations of the dialogue system.

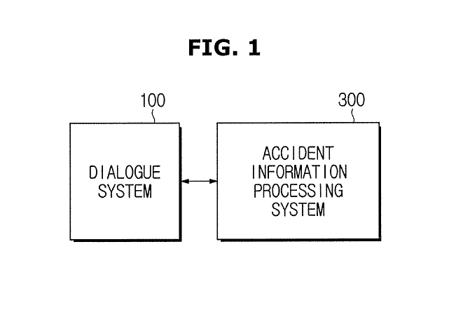

FIG. 1 is a control block diagram of a dialogue system and an accident information processing system according to exemplary embodiments of the present disclosure.

Referring to FIG. 1, a dialogue system 100 according to exemplary embodiments conducts a dialogue with a user on the basis of the user's voice and the user's inputs other than voice. In particular, the dialogue system 100 according to an embodiment acquires accident information from the user's voice, analyzes the accident information, determines the grade of the accident information, and delivers the accident information to the accident information processing system 300.

The accident information processing system 300 applies the classified accident information delivered by the dialogue system 100 to navigation information.

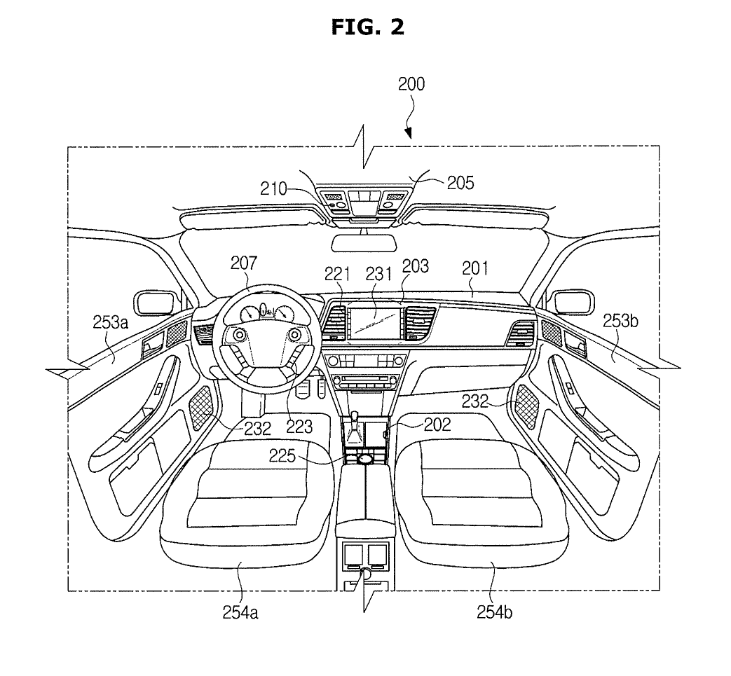

In detail, the accident information processing system 300 includes the entire audio-video-navigation (AVN) system installed in a vehicle 200 (see FIG. 2), an external server connected to the vehicle 200 through a communication device, and a vehicle or a user terminal that receives navigation information processed on the basis of various information collected by the external server.

As an example, the accident information processing system 300 may be a Transport Protocol Experts Group (TPEG) system. TPEG is a technology for providing traffic and travel related information to a navigation terminal of a vehicle in real time by means of digital multimedia broadcasting (DMB) broadcasting frequencies, and the TPEG system collects accident information delivered from closed-circuit televisions (CCTVs) installed on roads or in a plurality of vehicles.

Also, in some embodiments, the accident information processing system 300 may be a communication system that collects or processes various traffic information or the like and shares the traffic information with a mobile device carried by a user or an app of the mobile device through network communication.

The dialogue system 100 transmits and receives information to and from the accident information processing system 300 and exchanges situations and processing statuses of accident information delivered by the user. Thus, the accident information processing system 300 may deliver real-time updated information to other vehicles and drivers on a route related to the accident information as well as the user, and thus it is possible to increase the accuracy of route guidance or the possibility of safe driving.

FIG. 2 is a view showing an internal configuration of a vehicle according to exemplary embodiments of the present disclosure.

The dialogue system 100 according to some embodiments is installed in the vehicle 200 to perform dialogue with a user and acquire accident information. The dialogue system 100 delivers the acquired information to the accident information processing system 300 as electrical signals.

As an example, when the accident information processing system 300 includes an AVN device, the AVN device may change navigation guidance through the acquired accident information.

As another example, the accident information processing system 300 delivers the accident information to an external server through a communication device installed in the vehicle 200. In this case, the external server may receive the accident information delivered by the vehicle 200 and may use the accident information for real-time updating.

Referring to FIG. 2 again, a display 231 configured to display a screen necessary to perform vehicular control functions including an audio function, a video function, a navigation function, or a calling function and an input button 221 configured to receive a control command from the user may be provided in a center fascia 203, which is a central region of a dash board 201 inside the vehicle 200.

For convenience of driver manipulation, an input button 223 may be provided in a steering wheel 207, and a jog shuttle 225 acting as an input button may be provided in a center console region 202 between a driver seat 254a and a passenger seat 254b.

A module including the display 231, the input button 221, and a processor configured to generally control various functions may be referred to as an AVN terminal or a head device.

The display 231 may be implemented as one of various display devices, such as a liquid crystal display (LCD), a light-emitting diode (LED) display, a plasma display panel (PDP) and an organic light-emitting diode (OLED) display.

As shown in FIG. 2, the input button 221 may be provided as a hard key button in a region adjacent to the display 231. When the display 231 is implemented as a touch screen, the display 231 may additionally perform the function of the input button 221.

The vehicle 200 may receive a user command by means of a voice through a voice input device 210. The voice input device 210 may include a microphone configured to receive sound, convert the sound into electrical signals and output the electrical signals.

For effective voice inputs, the voice input device 210 may be provided in a headliner 205 as shown in FIG. 2. However, the disclosed embodiments of the vehicle 200 are not limited thereto, and the voice input device 210 may be provided in the dash board 201 or in the steering wheel 207. In addition, there is no limitation on the location of the voice input device 210 as long as the location is appropriate for receiving the user's voice.

A speaker 232 configured to output sound necessary to conduct dialogue with the user or provide a service desired by the user may be provided inside the vehicle 200. As an example, the speaker 232 may be provided inside a driver seat door 253a and a passenger seat door 253b.

The speaker may output a voice for navigation route guidance, a sound or voice included in audio/video content, a voice for providing information or a service desired by a user, a system utterance created in response to a user's utterance, or speech, or the like.

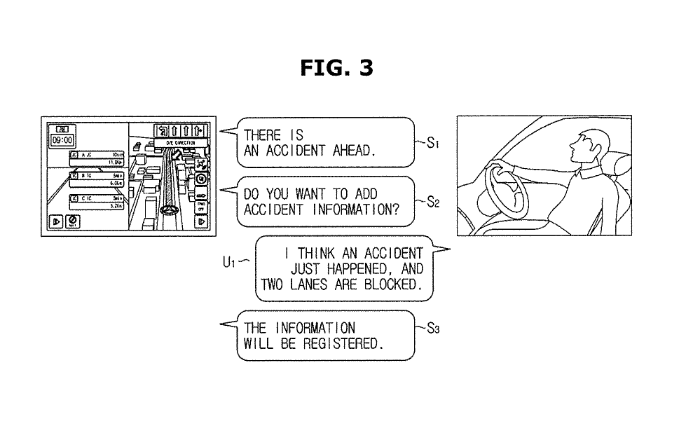

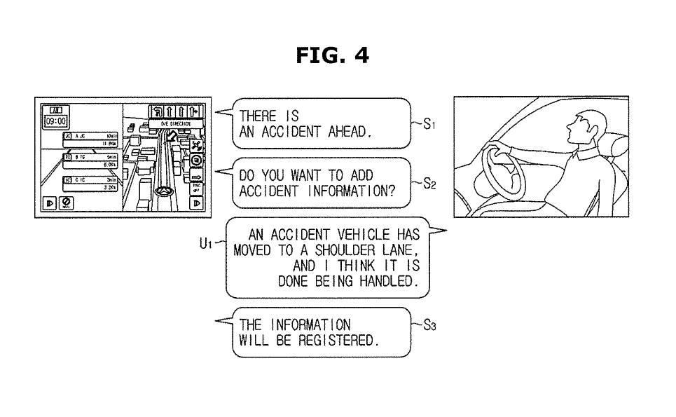

FIGS. 3 to 5 are views showing example dialogues that may be conducted between a dialogue system and a driver according to exemplary embodiments of the present disclosure.

Referring to FIG. 3, the dialogue system 100 may receive accident information about an accident happening on a driving route that is input from a vehicular controller or the like. In this case, the dialogue system 100 may output an utterance S1 (“There is an accident ahead.”) for recognition of accident information and also output an utterance S2 (“Do you want to add accident information?”) for asking whether to register the accident information.

A driver inputs accident information about an accident visible to him or her by means of his or her voice, and the dialogue system 100 may output a confirmation voice indicating that the grade of the accident information has been determined.

For example, when the driver inputs an utterance, or speech, U1 (“I think an accident just happened, and two lanes are blocked.”) for describing the accident in detail, the dialogue system 100 may output an utterance S3 (“The information will be registered.”) for confirming the information. It is to be understood that an “utterance” can be speech or any sound produced by a driver, or a component of a disclosed system or vehicle.

The dialogue system 100 may predict the time of the accident, the scale of the accident and the results of the accident on the basis of a speech, or voice, uttered by the user.

Referring to FIG. 4, the dialogue system 100 may output an utterance S1 (“There is an accident ahead.”) for recognizing accident information and also output an utterance S2 (“Do you want to add accident information?”) for asking about whether to register the accident information.

The driver confirms the accident information according to what he or she notices. For example, the driver may determine that the accident is being handled and does not interfere with driving. When the driver makes an utterance including such information, the dialogue system 100 extracts a processing status of the accident information from the user's utterance.

For example, when the driver inputs an utterance U1 (“An accident vehicle has moved to a shoulder lane, and I think it is done being handled.”) for describing the accident in detail, the dialogue system 100 may output an utterance S3 (“The information will be registered”) for confirming the information.

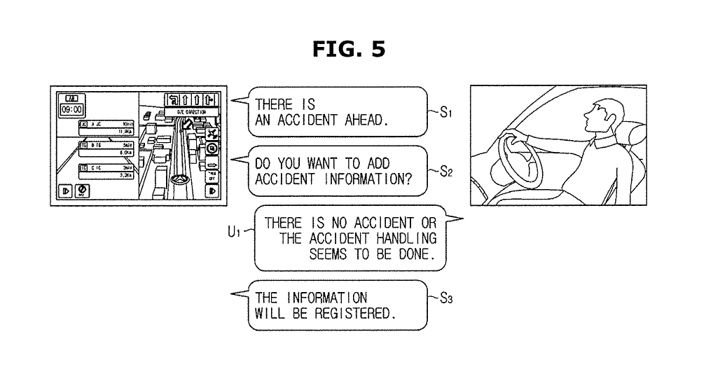

Referring to FIG. 5, the dialogue system 100 may output an utterance S1 (“There is an accident ahead.”) for recognizing accident information and also output an utterance S2 (“Do you want to add accident information?”) for asking whether to register the accident information.

Unlike the registered accident information, an actual situation may indicate that the accident handling is done or that there is no accident. When the driver makes an utterance including such a situation, the dialogue system 100 may deliver an output for deregistering the accident information from the accident information processing system 300.

For example, when the driver inputs an utterance U1 (“There is no accident or the accident handling seems to be done.”) for describing the accident in detail, the dialogue system 100 may output an utterance S3 (“The information will be registered.”) for confirming the information.

As described above, the dialogue system 100 encourages user participation through the acquired information and classifies the accident information through an accident processing status that may be received by a user, and thus it is possible to increase the accuracy of traffic information delivered by a navigation system and to specifically analyze the current status.

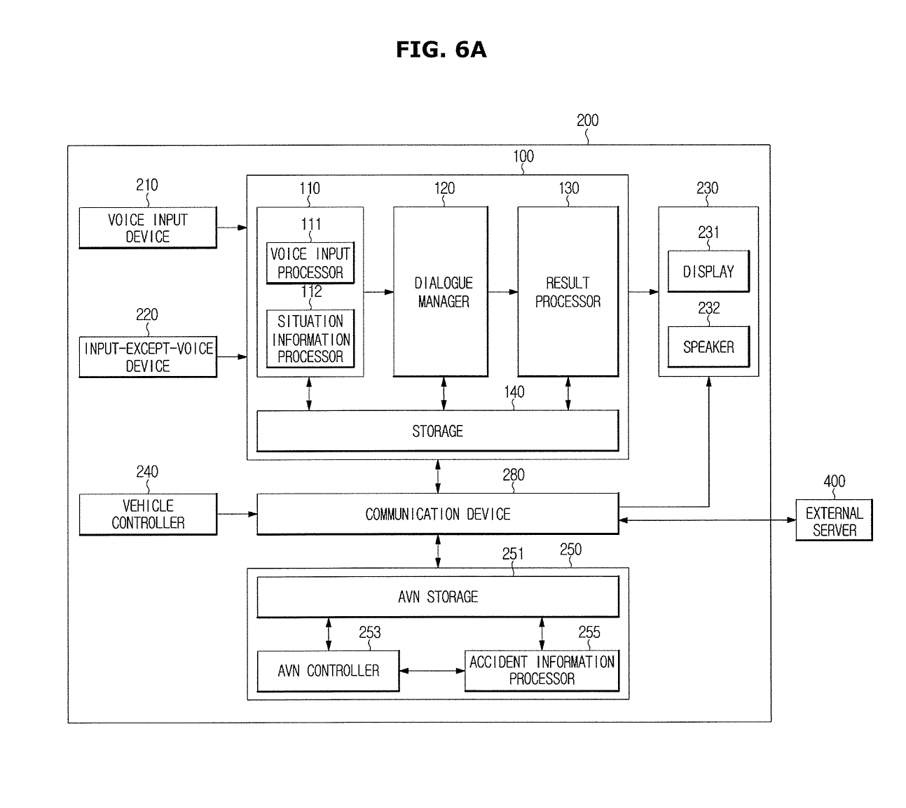

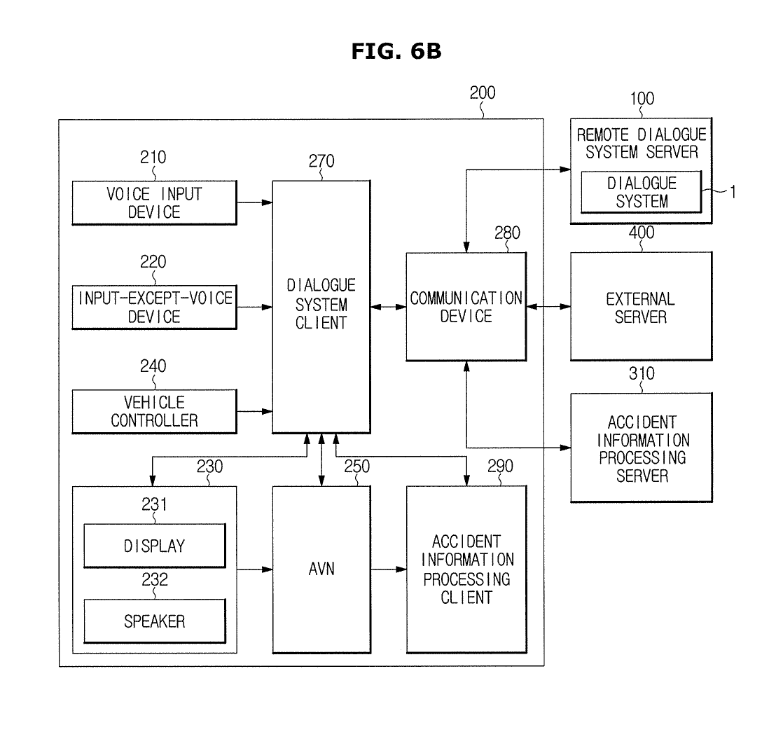

FIG. 6A is a control block diagram for a standalone method in which a dialogue system and an accident information processing system are provided in a vehicle according to exemplary embodiments of the present disclosure. FIG. 6B is a control block diagram for a vehicular gateway method in which a dialogue system and an accident information processing system are provided in a remote server and a vehicle serves only as a gateway for making a connection to the systems according to exemplary embodiments of the present disclosure. The methods will be described together below in order to avoid redundant descriptions.

First, referring to FIG. 6A, a dialogue system 100 including an input processor 110, a dialogue manager 120, a result processor 130 and a storage 140 may be included in a vehicle 200 in the vehicular standalone method.

In detail, the input processor 110 processes a user input including a user's voice and a user's inputs other than voice or an input including vehicle-related information or user-related information.

The dialogue manager 120 determines the user's intent by using a processing result of the input processor 110 and determines an action corresponding to the user's intent or a vehicular state.

The result processor 130 provides a specific service according to an output result of the dialogue manager 120 or outputs a system utterance for maintaining the dialogue.

The storage 140 stores various information necessary to perform the following operation.

The input processor 110 may receive two types of inputs, i.e., a user's voice and inputs other than voice. The inputs other than voice may include the user's input other than voice input through manipulation of an input device, vehicular state information indicating a state of the vehicle, driving environment information associated with a driving environment of the vehicle, user information indicating a state of the user, or the like. In addition to such information, when information associated with the vehicle and the user can be used to determine the user's intent or provide a service to the user, the associated information may become an input of the input processor 110. The user may include both a driver and a passenger.

According to exemplary embodiments, the input processor 110 may receive situation information including accident information about an accident happening on the current driving route of the vehicle from an AVN device 250. Also, the input processor 110 may determine information associated with the accident information, that is, the user's intent, through the user's voice.

In association with the user's voice input, the input processor 110 recognizes the user's voice, converts the voice into a text-type utterance sentence, and applies natural language understanding technology to the user's utterance sentence to discover the user's intent. The input processor 110 delivers information associated with the user's intent and the situation discovered through natural language understanding to the dialogue manager 120.

In association with the input of the situation information, the input processor 110 processes a current traveling state of the vehicle 200, a driving route delivered by the AVN device 250, accident information about an accident happening on the driving route, or the like and discovers a subject (hereinafter referred to as a domain) of the voice input of the user, classification grade (hereinafter referred to as an action) of the accident information, etc. The input processor 110 delivers the determined domain and action to the dialogue manager 120.

The dialogue manager 120 classifies by grade the accident information corresponding to the user's intent and current situation on the basis of the user's intent, the situation information, or the like delivered from the input processor 110.

Here, the action may refer to all operations performed to provide a specified service, and the type of action may be predefined. Depending on the case, the provided service and the performed action may have the same meaning.

According to exemplary embodiments, when an operation for classifying the accident information is performed, the dialogue manager 120 may set the action through the classification of the accident information. In addition, actions such as route guidance, vehicle state check, and filling station recommendation may be previously defined, and an action corresponding to a user's utterance or the like may be extracted according to an inference rule stored in the storage 140.

The types of the actions are not limited as long as an action can be performed by the dialogue system 100 through the vehicle 200 or through the mobile device and be predefined and also as long as an inference rule or a relation with another action/event which is associated with the action is stored.

The dialogue manager 120 delivers information regarding the determined action to the result processor 130. The result processor 130 generates and outputs a response and an instruction necessary to perform the delivered action. The dialogue response may be output by means of text, an image, or audio. When the instruction is output, a service such as vehicular control and external content provision corresponding to the output instruction may be performed.

The result processor 130 according to exemplary embodiments may deliver the action and the grade of the accident information determined by the dialogue manager 120 to the accident information processing system 300 including the AVN device 250. The storage 140 stores various information necessary for dialogue processing and service provision. For example, the storage 140 may store beforehand information associated with a domain, an action, a speech action, and a named entity which are used for a natural language understanding, may store a situation understanding table that is used to understand a situation from input information, and may store beforehand a determination criterion for classifying accident information through user's dialogue. The information stored in the storage 140 will be described below in more detail.

As shown in FIG. 6A, when the dialogue system 100 is included in the vehicle 200, the vehicle 200 itself may process dialogue with the user and provide a service required by the user. However, the vehicle 200 may bring information necessary for the dialogue processing and the service provision from an external server 400.

Meanwhile, all or only some of the elements of the dialogue system 100 may be included in the vehicle 200. The dialogue system 100 may be provided in a remote server, and the vehicle 200 acts as a gateway between the dialogue system 100 and the user. This will be described below in detail with reference to FIG. 6B.

The user's voice input to the dialogue system 100 may be input through the voice input device 210 provided in the vehicle 200. As described above with reference to FIG. 2, the voice input device 210 may include a microphone provided inside the vehicle 200.

Among user inputs, inputs other than voice may be input through an input-except-voice device 220. The input-except-voice device 220 may include input buttons 221 and 223 and a jog shuttle 225 that receive a command through the user's manipulation.

Also, the input-except-voice device 220 may include a camera that captures the user. Through an image captured by the camera, a gesture, a facial expression, or a gaze direction of the user, which is used as a command input means, may be recognized. Alternatively, through an image captured by the camera, it is possible to discover the user's state (e.g., a drowsy state).

The vehicle controller 240 and the AVN device 250 may input vehicle situation information to a dialogue system client 270. The vehicle situation information may include information stored in the vehicle 200 by default, such as a vehicle fuel type or vehicle state information acquired through various sensors provided in the vehicle 200 and may include environment information such as accident information.

The above-described camera in the disclosed embodiment may capture an accident happening ahead while the vehicle 200 is traveling. An image captured by the camera may be delivered to the dialogue system 100, and the dialogue system 100 may extract situation information associated with accident information, which cannot be extracted from the user's utterance.

Meanwhile, the camera installed in the vehicle 200 may be located outside or inside the vehicle and may include any device capable of capturing an image that may be used by the dialogue system 100 to classify the accident information by grade.

The dialogue system 100 discovers the user's intent and the situation by means of the user's input voice, the user's inputs other than voice input through the input-except-voice device 220, and various information input through the vehicle controller 240, and outputs a response for performing an action corresponding to the user's intent.

A dialogist output device 230 is a device configured to provide a visual, auditory, or tactile output to a dialogist and may include the display 231 and the speaker 232 which are provided in the vehicle 200. The display 231 and the speaker 232 may visually or audibly output a response to the user's utterance, a query for the user, or information requested by the user. Alternatively, a vibrating device may be installed in the steering wheel 207 to output a vibration.

The vehicle controller 240 may control the vehicle 200 so that the vehicle 200 performs an action corresponding to the user's intent or the current situation according to the response output by the dialogue system 100.

In detail, the vehicle controller 240 may deliver vehicle state information such as a remaining fuel amount, a rainfall, a rainfall rate, surrounding obstacle information, tire air pressure, current location, engine temperature, and vehicle speed, which are measured through various sensors provided in the vehicle 200, to the dialogue system 100.

Also, the vehicle controller 240 may include various elements such as an air conditioner, a window, a door, and a seat and may operate on the basis of a control signal delivered according to an output result of the dialogue system 100.

The vehicle 200 according to exemplary embodiments may include the AVN device 250. For convenience of description, the AVN device 250 is shown in FIG. 6A as being separate from the vehicle controller 240.

The AVN device 250 refers to a terminal or device capable of providing a navigation function for presenting a route to a destination and also capable of integratedly providing an audio function and a video function to the user.

The AVN device 250 includes an AVN controller 253 configured to control overall elements, an AVN storage 251 configured to store various information and data processed by the AVN controller 253, and an accident information processor 255 configured to receive accident information from the external server 400 and process classified accident information according to a processing result of the dialogue system 100.

In detail, the AVN storage 251 may store an image and a sound that are output through the display 231 and the speaker 232 by the AVN device 250 or may store a series of programs necessary to operate the AVN controller 253.

According to exemplary embodiments, the AVN storage 251 may store accident information processed by the dialogue system 100 and a classification grade thereof and may store new accident information changed from prestored accident information and a classification grade thereof.

The AVN controller 253 is a processor that controls the overall operation of the AVN device 250.

In detail, the AVN controller 253 processes a navigation operation for route guidance to a destination, plays music or the like, or processes a video/audio operation for displaying images depending on the user's input.

According to exemplary embodiments, the AVN controller 253 may also output accident information delivered by the accident information processor 255 while performing the travel guidance operation. Here, the accident information refers to an accident situation or the like included in the driving route delivered from the external server 400.

As described with reference to FIGS. 3 to 5, the AVN controller 253 may determine whether the accident information has been accepted on a driving route to be guided.

When the accident information is included on the driving route, the AVN controller 253 may display the accident information on the display 231 together with a previously displayed navigation indication. Also, the AVN controller 253 may deliver the accident information to the dialogue system 100 as the driving environment information. The dialogue system 100 may recognize the situation on the basis of the driving environment information and may output a dialogue as shown in FIGS. 3 to 5.

The disclosed embodiments are not limited to only a case in which the AVN controller 253 acquires information regarding the accident information. As an example, the dialogue system 100 may acquire the accident information through uttered dialogue from a user who has first acquired the accident information and thus may classify the accident information by grade.

In some embodiments, the dialogue system 100 may acquire the accident information from an image captured by the above-described camera, and may first utter dialogue for executing classification of the accident information.

The accident information processor 255 receives classified accident information processed by the dialogue system 100 according to the user's intent and determines whether the classified accident information is new accident information or whether to change prestored accident information. Also, the accident information processor 255 may deliver the accident information delivered by the dialogue system 100 to the external server 400.

The delivered accident information is used for traveling along the same driving route from the external server 400 and is utilized as navigation data. For convenience of description, the accident information processor 255 is separately shown. Instead, a processor may be sufficiently utilized as long as the process is configured to process accident information classified by the dialogue system 100 so that the accident information may be used for the operation of the AVN device 250. That is, the accident information processor 255 and the AVN controller 253 may be provided as a single chip.

The communication device 280 connects several elements and devices provided in the vehicle 200. Also, the communication device 280 connects the vehicle 200 with the external server 400 to enable an exchange of data such as the accident information.

The communication device 280 will be described below in detail with reference to FIG. 6B. Referring to FIG. 6B, the dialogue system 100 is provided in a remote dialogue system server 1, and the accident information processing system 300 is provided in an external accident information processing server 310. Thus, the vehicle 200 may act as a gateway that connects the user and the system.

In the vehicle gateway method, the remote dialogue system server 1 is provided outside the vehicle 200, and a dialogue system client 270 connected to the remote dialogue system server 1 through the communication device 280 is provided in the vehicle 200.

Also, an accident information processing client 290 configured to accept real-time accident information and deliver data regarding accident information classified by the user to an external accident information processing server 310 is provided in the vehicle 200.

The communication device 280 acts as a gateway configured to connect the vehicle 200 to the remote dialogue system server 1 and the external accident information processing server 310.

That is, the dialogue system client 270 and the accident information processing client 290 may function as an interface connected to an input/output device and collect, transmit, and receive data.

When the voice input device 210 and the input-except-voice device 220 provided in the vehicle 200 receive a user input and deliver the user input to the dialogue system client 270, the dialogue system client 270 may transmit input data to the remote dialogue system server 1 through the communication device 280.

The vehicle controller 240 may also deliver data detected by a vehicle detection device to the dialogue system client 270, and the dialogue system client 270 may transmit the data detected by the vehicle detection device to the remote dialogue system server 1 through the communication device 280.

The remote dialogue system server 1 may have the above-described dialogue system 100 to process input data, process a dialogue based on a result of processing the input data, and process a result based on a result of processing the dialogue.

Also, the remote dialogue system server 1 may bring information or content necessary to process the input data, manage the dialogue or process the result from the external server 400.

The vehicle 200 may also bring content necessary to provide a service needed by the user from an external content server 400 according to a response transmitted from the remote dialogue system server 1.

The external accident information processing server 310 collects accident information from the vehicle 200 and various other elements such as vehicles other than the vehicle 200 and CCTVs installed on roads. Also, the external accident information processing server 310 generates new accident information on the basis of data regarding accident information collected by the user in the vehicle 200 and the classification grade of the accident information delivered by the remote dialogue system server 1.

For example, the external accident information processing server 310 may accept new accident information from another vehicle. In this case, the accepted accident information may not include information regarding the scale or time of the accident.

The external accident information processing server 310 may deliver the accepted accident information to the vehicle 200. The user occupying the vehicle 200 may visually confirm the accident information and may input an utterance containing information regarding the scale of the accident and the time of the accident to the dialogue system client 270.

The remote dialogue system server 1 may process input data received from the dialogue system client 270 and may deliver information regarding the scale of the accident and the time of the accident of the accident information to the external accident information processing server 310 or the vehicle.

The external accident information processing server 310 receives detailed accident information or classified accident information from the dialogue system client 270 or the communication device 280 of the vehicle 200.

The external accident information processing server 310 may update the accepted accident information through the classified accident information and may deliver the accident information to still another vehicle or the like. Thus, it is possible to increase the accuracy of driving information or traffic information provided by the AVN device 250.

The communication device 280 may include one or more communication modules capable of communicating with an external apparatus. For example, the communication device 280 may include a short-range communication modules, a wired communication modules and a wireless communication modules.

The short-range communication modules may include at least one of various short-range communication modules that transmit and receive signals over a short range by means of a wireless communication network module such as a Bluetooth module, an infrared communication modules, a radio frequency identification (RFID) communication modules, a wireless local access network (WLAN) communication modules, a near field communication (NFC) module and a Zigbee communication modules.

The wired communication modules may include at least one of various cable communication modules such as a Universal Serial Bus (USB) module, a High Definition Multimedia Interface (HDMI) module, a Digital Visual Interface (DVI) module, a Recommended Standard-232 (RS-232) module, a power line communication modules or a plain old telephone service (POTS) module as well as various wired communication modules such as a Local Area Network (LAN) module, a Wide Area Network (WAN) module, and a Value Added Network (VAN) module.

The wireless communication modules may include at least one of various wireless communication modules capable of being connected to an Internet network in a wireless manner such as Global System for Mobile Communication (GSM) module, Code Division Multiple Access (CDMA) module, Wideband Code Division Multiple Access (WCDMA) module, Universal Mobile Telecommunications System (UMTS) module, Time Division Multiple Access (TDMA) module, Long Term Evolution (LTE) module, 4G module and 5G module as well as a WiFi module and a Wireless broadband module.

Meanwhile, the communication device 280 may further include internal communication modules (not shown) for communication between electronic devices inside the vehicle 200. Controller Area Network (CAN), Local Interconnection

Network (LIN), FlexRay, Ethernet, or the like may be used as an internal communication protocol of the vehicle 200.

The dialogue system client 270 may transmit and receive data to and from the external server 400 or the remote dialogue system server 1 by means of wireless communication modules. Also, the dialogue system client 270 may perform V2X communication by means of wireless communication modules. Also, the dialogue system client 270 may transmit and receive data to and from a mobile device connected to the vehicle 200 by means of short-range communication modules or wireless communication modules.

The control block diagrams described with reference to FIGS. 6A and 6B are just an example of the disclosed present disclosure. That is, the dialogue system 100 is not limited as long as the dialogue system 100 includes an element and device capable of recognizing a user's voice, acquiring accident information and then processing a result of classifying the accident information.

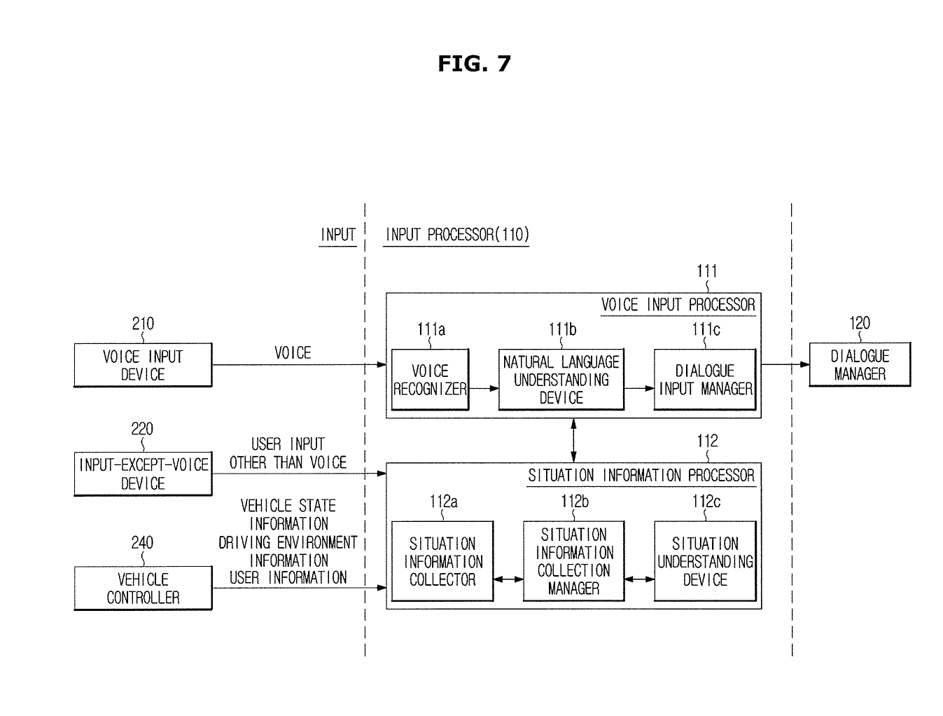

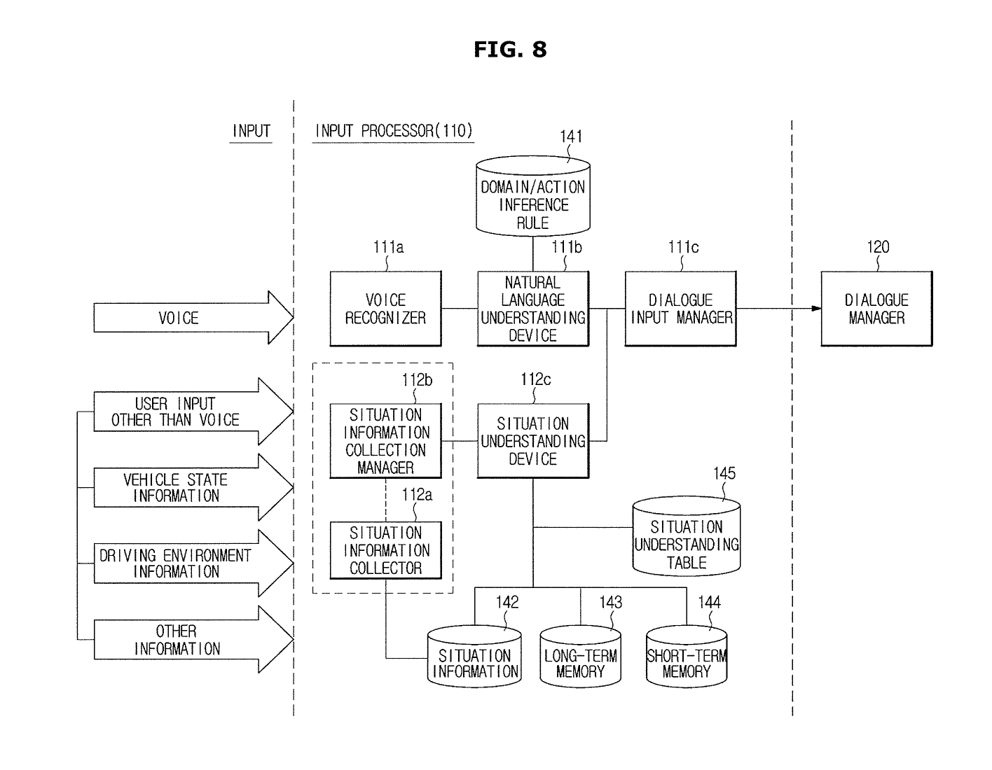

FIGS. 7 and 8 are detailed control block diagrams showing an input processor among the elements of the dialogue system according to exemplary embodiments of the present disclosure.

Referring to FIG. 7, the input processor 110 may include a voice input processor 111 configured to process a voice input and a situation information processor 112 configured to process situation information.

A user's voice input through the voice input device 210 is transmitted to the voice input processor 111, and user inputs other than voice input through the input-except-voice device 220 are transmitted to the situation information processor 112.

The vehicle controller 240 transmits various situation information such as vehicle state information, driving environment information, and user information to the situation information processor 112. In particular, the driving environment information according to an embodiment may include the accident information delivered through the vehicle controller 240 or the AVN device 250. The driving environment information and the user information may be provided from a mobile device connected to the external server 400 or the vehicle 200.

In detail, the vehicle state information may include information indicating the state of the vehicle, which is information acquired by sensors provided in the vehicle 200, and may include information stored in the vehicle, which is information associated with the vehicle such as the fuel type of the vehicle.

The driving environment information may be information acquired by sensors provided in the vehicle 200 and may include image information acquired by a front camera, a rear camera, or a stereo camera, obstacle information acquired by sensors such as a radar, a Lidar, and an ultrasonic sensor, rainfall/rain velocity information acquired by a rain sensor, or the like.

Also, the driving environment information is information acquired through V2X and includes traffic light information, access or collision possibility information of nearby vehicles, or the like in addition to traffic situation information, accident information and weather information.

The disclosed accident information may include information about an accident and a blocked road that are present at the current location and on a driving route to be guided by the AVN device 250 and may include various information which is the basis of a navigation function that enables the user to bypass the blocked road.

As an example, the accident information may include vehicle collisions and natural disasters that cause congestion on the driving route, and the blocked-road information may include a situation such as asphalt construction in which a road is being blocked unnaturally.

The user information may include information regarding the user's state acquired through a camera or a biometric signal measurement device provided in the vehicle 200, user-related information that is directly input by the user by means of an input device provided in the vehicle 200, user-related information stored in the external server 400, information stored in a mobile device connected to the vehicle, or the like.

The voice input processor 111 may include a voice recognizer 111a configured to recognize the user's input voice and output the user's voice as a text-based utterance sentence, a natural language understanding device 111b configured to apply natural language understanding technology to the utterance sentence to determine the user's intent involved in the utterance sentence, and a dialogue input manager 111c configured to deliver a natural language understanding result and situation information to the dialogue manager 120.

The voice recognizer 111a may include a speech recognition engine, and the speech recognition engine may apply a voice recognition algorithm to an input voice to recognize a voice uttered by the user and generate a result of the recognition.

In this case, the input voice may be converted into a more useful form for voice recognition. The voice recognizer 111a detects a start point and an end point from a voice signal to detect an actual voice section included in the input voice. This is called end point detection (EPD).

Also, the voice recognizer 111a may apply a feature vector extraction technique such as Cepstrum, Linear Predictive Coefficient (LPC), Mel Frequency Cepstral Coefficient (MFCC) or Filter Bank Energy to the detected section to extract a feature vector of the input voice.

Also, the voice recognizer 111a may obtain a result of the recognition through a comparison between the extracted feature vector and a trained reference pattern. To this end, an acoustic model for modeling and comparing voice signal characteristics and a language model for modeling a linguistic order relationship of words or syllables corresponding to recognized speech may be used. To this end, a sound model/language model database (DB) may be stored in the storage 140.

A sound model may be classified into a direct comparison method of setting an object to be recognized as a feature vector model and comparing the feature vector model to a feature vector of voice data and into a statistical modeling method of statistically processing and using a feature vector of an object to be recognized.

The direct comparison method is a method of setting a unit such as a word or a phoneme, which is an object to be recognized, as a feature vector model and determining how similar an input voice is to the feature vector model. A representative example is a vector quantization method. The vector quantization method is a method of mapping a feature vector of input voice data to a codebook, which is a reference model, to encode the feature vector into representative values and comparing the encoded values to each other.

The statistical modeling method is a method of configuring a unit for an object to be recognized as a state sequence and using a relationship between state sequences. The state sequence may be composed of a plurality of nodes. The method of using a relationship between state sequences is classified into Dynamic Time Warping (DTW), Hidden Markov Model (HMM), a neural-network-based method and so on.

DTW is a method of compensating for a time-axis difference during comparison to a reference model in consideration of dynamic characteristics of a voice in which the length of a signal varies with time even though the same person pronounces the same word. HMM is a recognition technique of assuming a voice to be a Markov process having a state transition probability and an observation probability of a node (an output symbol) at each state, estimating the state transition probability and the observation probability of the node through learned data and calculating the probability that an input voice will occur in the estimated model.

Meanwhile, a linguistic model for modeling a linguistic order relationship of words or syllables can reduce acoustic ambiguity and recognition errors by applying the order relationship between the words to units obtained through voice recognition. The linguistic model may include a statistical linguistic model and a finite state automaton (FSA)-based model. As the statistical linguistic model, a contiguous sequence of words such as a unigram, a bigram and a trigram is used.

The voice recognizer 111a may use any one of the above-described methods to recognize a voice. For example, the voice recognizer 111a may use a sound model to which HMM is applied and may use an N-best search method in which a sound model and a voice model are integrated. The N-best search method can enhance recognition performance by selecting N recognition result candidates by means of a sound model and a linguistic model and re-evaluating the rankings of the candidates.

The voice recognizer 111a may calculate a confidence value in order to secure reliability of the recognition result. The confidence value is a measure of how reliable a voice recognition result is. As an example, the confidence value may be defined as a relative probability that a speech corresponding to phonemes or words that are a recognition result has originated from other phonemes or words. Accordingly, the confidence value may be represented in the range of 0 to 1 or in the range of 0 to 100.

When the confidence value exceeds a predetermined threshold, the voice recognizer 111a outputs a recognition result to enable an operation corresponding to the recognition result to be performed. When the confidence value is less than or equal to the threshold, the voice recognizer 111a may reject the recognition result.

A text-based utterance sentence that is the recognition result of the voice recognizer 111a is input to the natural language understanding device 111b.

The natural language understanding device 111b may determine the user's intent involved in the utterance sentence by applying natural language understanding technology to the utterance sentence. Accordingly, the user may input a command through a natural dialogue, and the dialogue system 100 may induce a command that may be input through dialogue or may provide a service required by the user.

First, the natural language understanding device 111b performs a morphological analysis on the text-based utterance sentence. A morpheme is the smallest unit of meaning and indicates the smallest semantic element that can no longer be segmented. Accordingly, the morphological analysis is the first step for natural language understanding and changes an input character string to a morpheme string.

The natural language understanding device 111b extracts a domain from the utterance sentence on the basis of a result of the morphological analysis. A domain is capable of identifying the subject of a speech uttered by a user. For example, a database of domains indicating various subjects such as accident information, route guidance, weather search, traffic search, schedule management, refueling warning and air control is built.

The natural language understanding device 111b may recognize an entity name from the utterance sentence. An entity name is a proper noun of a person, a place, an organization, a time, a date, a monetary unit, or the like. Entity name recognition is a task of identifying an entity name from a sentence and determining the type of the identified entity name. The natural language understanding device 111b may extract important keywords from a sentence through the entity name recognition to understand the meaning of the sentence.

The natural language understanding device 111b may analyze a speech action of the utterance sentence. Speech action analysis is a task of analyzing a user's utterance intent and is used to determine an utterance intent, i.e., whether a user is asking a question, making a request, making a response, or just expressing an emotion.

The natural language understanding device 111b extracts an action corresponding to a user's utterance intent. The natural language understanding device 111b determines the user's utterance intent on the basis of information such as a domain, an entity name, and a speech action corresponding to the utterance sentence and extracts the action corresponding to the utterance intent. An action may be defined by an object and an operator.

Also, the natural language understanding device 111b may extract a factor related to action execution. The factor related to action execution may be a valid factor that is directly necessary to perform an action or an invalid factor that is used to extract such a valid factor.

For example, when the user's utterance sentence is “an accident just happened,” the natural language understanding device 111b may extract “accident information” as a domain corresponding to the utterance sentence and may extract “accident information classification” as an action. The speech action corresponds to “response.”

An entity name “just” corresponds to [factor: time] associated with action execution, but detailed time or GPS information may be necessary to determine an actual accident time of the accident information. In this case, [factor: time: just] extracted by the natural language understanding device 111b may be a candidate factor for determining the accident time of the accident information.

The natural language understanding device 111b may also extract a means for expressing mathematical relationships between a word and a word and between a sentence and a sentence, such as a parse tree.

A morphological analysis result, domain information, action information, speech action information, extracted factor information, entity name information, and a parse tree, which are processing results of the natural language understanding device 111b, are delivered to the dialogue input manager 111c.

The situation information processor 112 may include a situation information collector 112a configured to collect information from the input-except-voice device 220 and the vehicle controller 240, a situation information collection manager 112b configured to manage collection of situation information, and a situation understanding device 112c configured to understand a situation on the basis of a result of the natural language understanding result and the collected situation information.

The input processor 110 may include a memory configured to store a program for performing the above-described operation or the following operation and a processor configured to execute the stored program. At least one memory and at least one processor may be provided. When a plurality of memories or processors is provided, the memories or processors may be integrated on a single chip and may be physically separated from each other.

Also, the voice input processor 111 and the situation information processor 112 included in the input processor 110 may be implemented using a single processor or separate processors.

The situation information processor 112 will be described below in detail with reference to FIG. 8. In particular, referring to FIG. 8, it will be described in detail how elements of the input processor 110 process input data by means of the information stored in the storage 140.

Referring to FIG. 8, the natural language understanding device 111b may use a domain/action inference rule DB 141 to perform domain extraction, entity name recognition, speech action analysis and action extraction.

A domain extraction rule, a speech action analysis rule, an entity name conversion rule, an action extraction rule, etc. may be stored in the domain/action inference rule DB 141.

Other information such as user inputs other than voice, vehicle state information, driving environment information, and user information may be input to the situation information collector 112a and may be stored in a situation information DB 142, a long-term memory 143 or a short-term memory 144.

For example, accident information delivered by the AVN device 250 may be included in the situation information DB 142, and such accident information may be unnecessary when the vehicle 200 passes through a corresponding accident location. Such accident information is stored in the short-term memory 144. However, when the scale of an accident included in the accident information is large and a driving route corresponds to a usual route of a user, the accident information may be stored in the long-term memory 143.

In addition, data meaningful to a user, such as the user's current state, the user's preference/disposition, or data for determining the current state, preference, or disposition, may be stored in the short-term memory 144 and the long-term memory 143.

Long-term information with guaranteed permanence such as the user's phone book, schedule, preference, education, personality, occupation, and family-related information may be stored in the long-term memory 143. Short-term information without guaranteed permanence or with uncertain permanence such as current/previous location, the day's schedule, previous dialogue content, dialogue participants, surrounding situations, a domain, and a driver's state may be stored in the short-term memory 144. Depending on the type of data, there may be data stored in two or more storages among the situation information DB 142, the short-term memory 144 and the long-term memory 143.

Also, information determined as having guaranteed permanence among information stored in the short-term memory 144 may be sent to the long-term memory 143.

Also, information to be stored in the long-term memory 143 may be acquired using information stored in the short-term memory 144 or the situation information DB 142. For example, a user's preference may be acquired by analyzing destination information or dialogue content accumulated for a certain period of time and may be stored in the long-term memory 143.

The acquisition of information to be stored in the long-term memory 143 by using the information stored in the short-term memory 144 or the situation information DB 142 may be performed in the dialogue system 100 or in a separate external system.

In the former case, the acquisition may be performed by a memory manager 135 of the result processor 130, which will be described below. In this case, data used to acquire meaningful information or permanent information such as a user's preference or disposition among data stored in the short-term memory 144 or the situation information DB 142 may be stored in the long-term memory 143 in the form of a log file. The memory manager 135 analyzes data accumulated for a certain period of time to acquire permanent data and stores the acquired data in the long-term memory 143 again. In the long-term memory 143, a location where the permanent data is stored and a location where the data is stored in the form of a log file may be different from each other.

Alternatively, the memory manager 135 may determine permanent data among the data stored in the short-term memory 144 and may move and store the permanent data in the long-term memory 143.

The dialogue input manager 111c may deliver the output result of the natural language understanding device 111b to the situation understanding device 112c and may obtain situation information associated with action execution.

The situation understanding device 112c may determine situation information associated with action execution corresponding to a user's utterance intent with reference to action-based situation information stored in the situation understanding table 145.

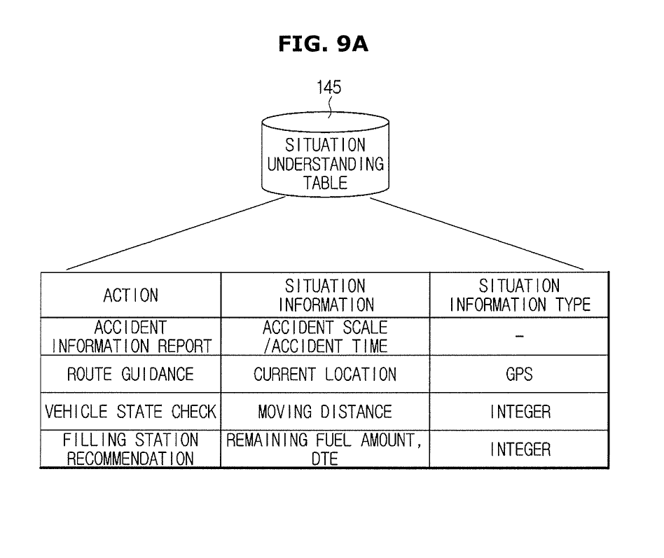

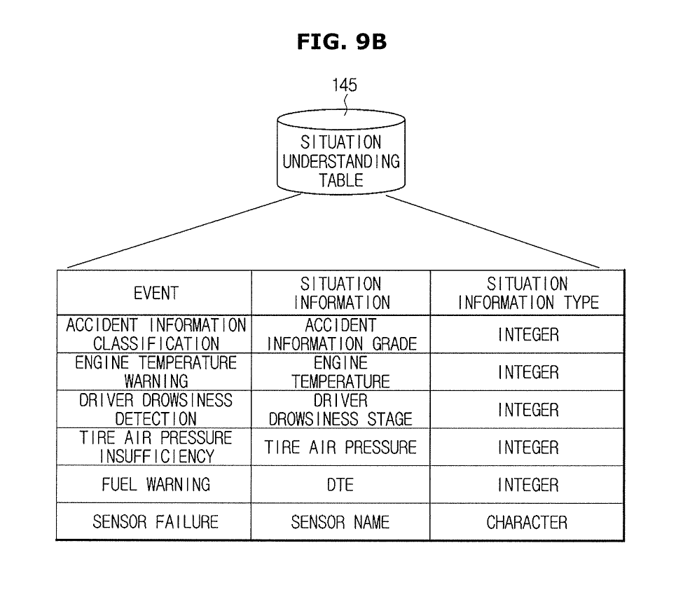

FIGS. 9A and 9B are views showing example information stored in a situation understanding table according to exemplary embodiments of the present disclosure.

Referring to the example of FIG. 9A, for example, when the action is an accident information report, the situation information may require an accident scale and an accident time. When the action is route guidance, the situation information may require a current location, and the situation information type may be GPS information. When the action is a vehicle state check, the situation information may require a moving distance, and the situation information type may be an integer. When the action is a filling station recommendation, the situation information may require a remaining fuel amount and a distance to empty (DTE) and the situation information type may be an integer.

Referring to FIG. 8 again, when the situation information associated with action execution corresponding to the user's utterance intent is prestored in the situation information DB 142, the long-term memory 143, or the short-term memory 144, the situation understanding device 112c brings corresponding information from the situation information DB 142, the long-term memory 143, or the short-term memory 144 and delivers the corresponding information to the dialogue input manager 111c.

When the situation information associated with action execution corresponding to the user's utterance intent is not stored in the situation information DB 142, the long-term memory 143, or the short-term memory 144, the situation understanding device 112c requests necessary information from the situation information collection manager 112b. The situation information collection manager 112b enables the situation information collector 112a to collect the necessary information.

The situation information collector 112a may collect data periodically or upon an occurrence of a specified event. Alternatively, the situation information collector 112a may usually collect data periodically and further collect data upon an occurrence of a specified event. Alternatively, the situation information collector 112a may collect data when a data collection request is input from the situation information collection manager 112b.

The situation information collector 112a collects the necessary information, stores the information in the situation information DB 142 or the short-term memory 144 and transmits an acknowledgement signal to the situation information collection manager 112b.

The situation information collection manager 112b transmits an acknowledgement signal to the situation understanding device 112c, and the situation understanding device 112c brings the necessary information from the situation information DB 142, the long-term memory 143, or the short-term memory 144 and delivers the necessary information to the dialogue input manager 111c.

As a detailed example, when the action corresponding to the user's utterance intent is route guidance, the situation understanding device 112c may search a situation understanding table 145 and become aware that the situation information associated with route guidance is a current location.

When the current location is stored in the short-term memory 144, the situation understanding device 112c brings the current location from the short-term memory 144 and delivers the current location to the dialogue input manager 111c.

When the current location is not stored in the short-term memory 144, the situation understanding device 112c requests the current location from the situation information collection manager 112b, and the situation information collection manager 112b enables the situation information collector 112a to acquire the current location from the vehicle controller 240.

The situation information collector 112a collects the current location, stores the current location in the short-term memory 144 and transmits an acknowledgement signal to the situation information collection manager 112b. The situation information collection manager 112b transmits an acknowledge signal to the situation understanding device 112c and the situation understanding device 112c brings current location information from the short-term memory 144 and delivers the current location information to the dialogue input manager 111c.

The dialogue input manager 111c may deliver an output of the natural language understanding device 111b and an output of the situation understanding device 112c and may perform management so that redundant input does not enter the dialogue manager 120. In this case, the output of the natural language understanding device 111b and the output of the situation understanding device 112c may be delivered to the dialogue manager 120 independently or in a combination thereof.

Meanwhile, when the situation information collection manager 112b determines that the specified event has occurred because the data collected by the situation information collector 112a satisfies a predetermined condition, the situation information collection manager 112b may transmit an action trigger signal to the situation understanding device 112c.

The situation understanding device 112c searches the situation understanding table 145 for situation information associated with a corresponding event. When the situation information is not stored, the situation understanding device 112c transmits a signal requesting the situation information to the situation information collection manager 112b.

Referring to the example of FIG. 9B, situation information associated with events and the type of the situation information may be stored for each event in the situation understanding table 145.

For example, when an event that has occurred is accident information classification, an integer-type accident information grade may be stored as associated situation information. Also, when an event that has occurred is an engine temperature warning, an integer-type engine temperature may be stored as associated situation information. When an event that has occurred is driver drowsiness detection, an integer-type driver drowsiness stage may be stored as associated situation information. When an event that has occurred is tire air pressure insufficiency, an integer-type tire air pressure may be stored as associated situation information. When an event that has occurred is a fuel warning, an integer-type DTE may be stored as associated situation information. When an event that has occurred is sensor failure, a character-type sensor name may be stored as associated situation information.

Referring to FIG. 8 again, the situation information collection manager 112b collects necessary situation information through the situation information collector 112a and transmits an acknowledgement signal to the situation understanding device 112c. The situation understanding device 112c brings necessary situation information from the situation information DB 142, the long-term memory 143, or the short-term memory 144 and delivers the situation information to the dialogue input manager 111c in addition to action information. The dialogue input manager 111c inputs an output of the situation understanding device 112c to the dialogue manager 120.

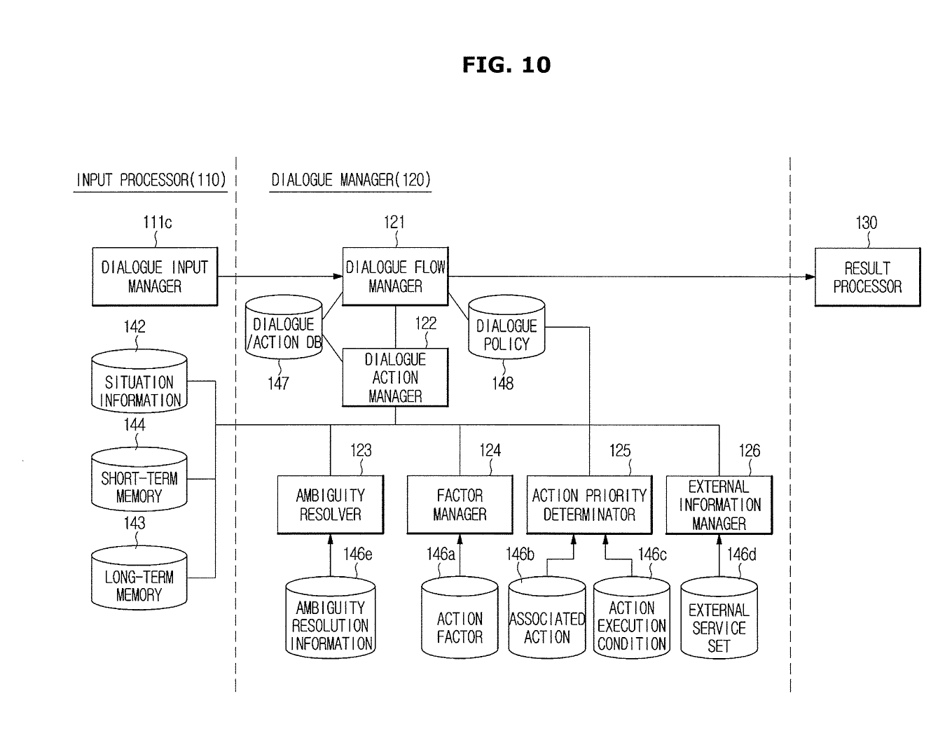

FIG. 10 is a detailed control block diagram of a dialogue manager according to exemplary embodiments of the present disclosure.

Referring to FIG. 10, the dialogue manager 120 may include a dialogue flow manager 121 configured to make a request to create/delete/update a dialogue or an action, a dialogue action manager 122 configured to create/delete/update a dialogue or an action according to a request from the dialogue flow manager 121, an ambiguity resolver 123 configured to resolve ambiguity of a situation and ambiguity of a dialogue to ultimately clarify a user's intent, a factor manager 124 configured to manage a factor necessary for action execution, an action priority determinator 125 configured to determine whether to execute a plurality of candidate actions and to determine priorities thereof and an external information manager 126 configured to manage an external content list and related information and manage factor information necessary for an external content query.

The dialogue manager 120 may include a memory configured to store a program for performing the above-described operation or the following operations and may include a processor configured to execute the stored program. At least one memory and at least one processor may be provided. When a plurality of memories or processors is provided, the memories or processors may be integrated on a single chip and may be physically separated from each other.

Also, the elements included the dialogue manager 120 may be implemented using a single processor or using separate processors. Further, the dialogue manager 120 and the input processor 110 may be implemented using a single processor or using separate processors.

The natural language understanding result (an output of the natural language understanding device 111b) and the situation information (an output of the situation understanding device 112c), which are outputs of the dialogue input manager 111c, are input to the dialogue flow manager 121. The output of the natural language understanding device 111b includes, in addition to a domain, an action, and so on, information about the content itself uttered by a user such as a morphological analysis result. The output of the situation understanding device 112c may include an event determined by the situation information collection manager 112b in addition to the situation information.

The dialogue flow manager 121 searches for whether a dialogue task or an action task corresponding to an input originating from the dialogue input manager 111c is present in a dialogue/action DB 147.

The dialogue/action DB 147 is a storage space for managing a dialogue state and an action state and may store a dialogue state of an ongoing dialogue and action states of ongoing actions and scheduled preliminary actions. For example, a terminated dialogue/action state, a suspended dialogue/action state, an ongoing dialogue/action state and a scheduled dialogue/action state may be stored in the dialogue/action DB 147.

Also, the dialogue/action DB 147 may store an action switching/nesting state, a switched action index, an action change time, the last output state of a screen/voice/instruction and so on.

For example, when driving environment information indicating that there is accident information is delivered by the input processor 110, the dialogue flow manager 121 determines whether a corresponding domain and event (or action) is stored in the dialogue/action DB 147. When there is a domain (e.g., accident information classification) and an event (e.g., classification by grade), the dialogue flow manager 121 may determine the domain and the event as a dialogue task or an action task corresponding to an input from the dialogue input manager 111c.

As another example, when a user utterance is input and a domain and action corresponding to the user utterance are not extracted, the dialogue flow manager 121 may generate any task or may request the dialogue action manager 122 to refer to a most recently stored task.

When a dialogue task or an action task corresponding to an output of the input processor 110 is not present in the dialogue/action DB 147, the dialogue flow manager 121 requests the dialogue action manager 122 to generate a new dialogue task and action task.

When managing a dialogue flow, the dialogue flow manager 121 may refer to a dialogue policy DB 146. The dialogue policy DB 148 stores a policy for a dialogue, more particularly a policy for selecting/starting/proposing/stopping/terminating a dialogue.

Also, the dialogue policy DB 148 may store a policy for when and how a system outputs a response, a policy for making a response in interaction with multiple services, and a policy for deleting a conventional action and replacing the conventional action with another action.

For example, when there are a plurality of candidate actions or there are a plurality of actions corresponding to a user's intent or a situation (action A and action B), both a policy for generating a response to two actions at one time (e.g., “Do you want to execute action A and then action B?”) and a policy for generating a response to one action and then generating a separate response to the other action (e.g., “Action A will be performed. Do you want to execute action B?”) are possible.

Also, the dialogue policy DB 147 may store a policy for determining priorities of the candidate actions. The dialogue action manager 122 allocates a storage space to the dialogue/action DB 147 to generate a dialogue task and an action task corresponding to the output of the input processor 110.

Meanwhile, when a domain and an action cannot be extracted from the user utterance, the dialogue action manager 122 may generate any dialogue state. In this case, as will be described below, the ambiguity resolver 123 may determine a user's intent on the basis of the user's utterance content, surrounding conditions, vehicle states, user information, etc., and may determine an appropriate action corresponding thereto.

When a dialogue task or an action task corresponding to an output of the input processor 110 is present in the dialogue/action DB 147, the dialogue flow manager 121 requests the dialogue action manager 122 to refer to a corresponding dialogue task and action task.

The factor manager 124 may search an action factor DB 146a for a factor used to execute each candidate action (hereinafter referred to as an action factor). The factor manager 124 may acquire factor values of all the candidate actions and may acquire only a factor value of a candidate action determined as being executable by the action priority determiner 125.

Also, the factor manager 124 may selectively use various kinds of factor values indicating the same information. The factor manager 124 brings a factor value of a factor found in the action factor DB 146a from a corresponding reference location. The reference location from which the factor value may be brought may be at least one of the situation information DB 142, the long-term memory 143, the short-term memory 144, the dialogue/action state DB 147 and the external content server 400.

When the factor manager 124 brings a factor value from the external content server 400, the factor value may be brought through the external information manager 126.

The action priority determiner 125 searches an associated-action DB 146b for an action list associated with an action or an event included in the output of the input processor 110 and extracts a candidate action from the action list.

For example, the associated-action DB 146b may represent actions associated with each other and a relationship therebetween and may represent and an action associated with an event and a relationship therebetween. For example, actions such as route guidance, accident information classification, detour search, and point acquisition guidance may be classified as associated actions and a relationship therebetween may correspond to interrelation.

The dialogue system 100 according to exemplary embodiments induces users to participate in classifying accident information. When a user inputs detailed situations (an accident scale, an accident time, and termination of accident handling) of the accident information, the dialogue system 100 also extracts, in association with the user's input, an action for detour search or an action for point acquisition guidance caused by a user's participation.

The action priority determiner 125 searches an action execution condition DB 146c for a condition for executing each candidate action. For example, when detour search is a candidate action, the action priority determinator 125 may determine a distance from a current location of the vehicle 200 to an accident location as the action execution condition. When the distance from the current location to the accident location is less than or equal to a predetermined distance, the action priority determinator 125 may conduct a dialogue associated with detour search while conducting a dialogue about accident information classification.

The action priority determinator 125 delivers a candidate action execution condition to the dialogue action manager 122, and the dialogue action manager 122 updates the action state of the dialogue/action state DB 147 by adding an action execution condition for each candidate action to the action state.

The action priority determinator 125 may search the situation information DB 142, the long-term memory 143, the short-term memory 144 or the dialogue/action state DB 147 for a factor necessary to determine an action execution condition (hereinafter referred to as a condition determination factor) and may determine whether to execute each candidate action by means of the factor.

When the factor used to determine the action execution condition is not stored in the situation information DB 142, the long-term memory 143, the short-term memory 144, or the dialogue/action state DB 147, the action priority determinator 125 may bring the necessary factor from the external server 400 or the external accident information processing server 310.

The external information manager 126 may determine where to bring information with reference to an external service set DB 146d. When the factor used to determine the action execution condition is not stored in the situation information DB 142, the long-term memory 143, the short-term memory 144 or the dialogue/action state DB 147, the external information manager 126 may bring the necessary factor from the external server 400.

The external service set DB 146d stores information about an external content server linked with the dialogue system 100. For example, the external service set DB 146d may store information regarding an external service name, the description of an external service, the type of information provided by an external service, a method of using an external service, an external service provider, etc.

The factor value acquired by the factor manager 124 is delivered to the dialogue action manager 122, and the dialogue action manager 122 updates the dialogue/action state DB 147 by adding a factor value for each candidate action to the action state.

When there is no ambiguity in a dialogue or situation, the dialogue action manager 122 may obtain necessary information according to the operation of the factor manager 124 and the external information manager 126 and may manage the dialogue and action. When there is ambiguity in a dialogue or situation, it is difficult to provide an appropriate service needed by a user using only the operations of the action priority determinator 125, the factor manager 124 and the external information manager 126.

In this case, the ambiguity resolver 123 may resolve ambiguity in the dialogue or ambiguity in the situation. For example, when an anaphoric word or phrase such as “the man,” “there yesterday,” “dad,” “mom,” “grandmother,” “daughter-in-law,” or the like is contained in a dialogue and it is ambiguous what the word or phrase refers to in the dialogue, the ambiguity resolver 123 may resolve the ambiguity or propose guidance for resolving the ambiguity with reference to the situation information DB 142, the long-term memory 143 or the short-term memory 144.

For example, an ambiguous word or phrase, such as “there yesterday,” “large store near the home,” and “just now” may correspond to a factor value of an action factor or a factor value of a condition determination factor. However, in this case, it is not possible to actually execute an action or determine an action execution condition by using only a corresponding word or phrase because of its ambiguity.

The ambiguity resolver 123 may resolve the ambiguity of the factor value with reference to the information stored in the situation information DB 142, the long-term memory 143 or the short-term memory 144. Alternatively, if necessary, the ambiguity resolver 123 may bring necessary information from the external content server 400 by means of the external information manager 126.

For example, the ambiguity resolver 123 may determine that a phrase “just now” refers to a time at which the AVN device 250 acquired accident information and delivered the accident information to the dialogue system 100 with reference to the short-term memory 144. The ambiguity resolver 123 may determine information necessary for a factor “just now” with reference to a time stored in the storage.

Also, when an action (an object or an operator) is not clearly extracted by the input processor 110 or when a user's intent is ambiguous, the ambiguity resolver 123 may determine the user's intent with reference to an ambiguity resolution information DB 146e and determine an action corresponding thereto.

When the dialogue manager 120 establishes a dialogue policy and obtains information necessary for a factor, the dialogue flow manager 121 delivers a determined dialogue and an output signal to the result processor 130.

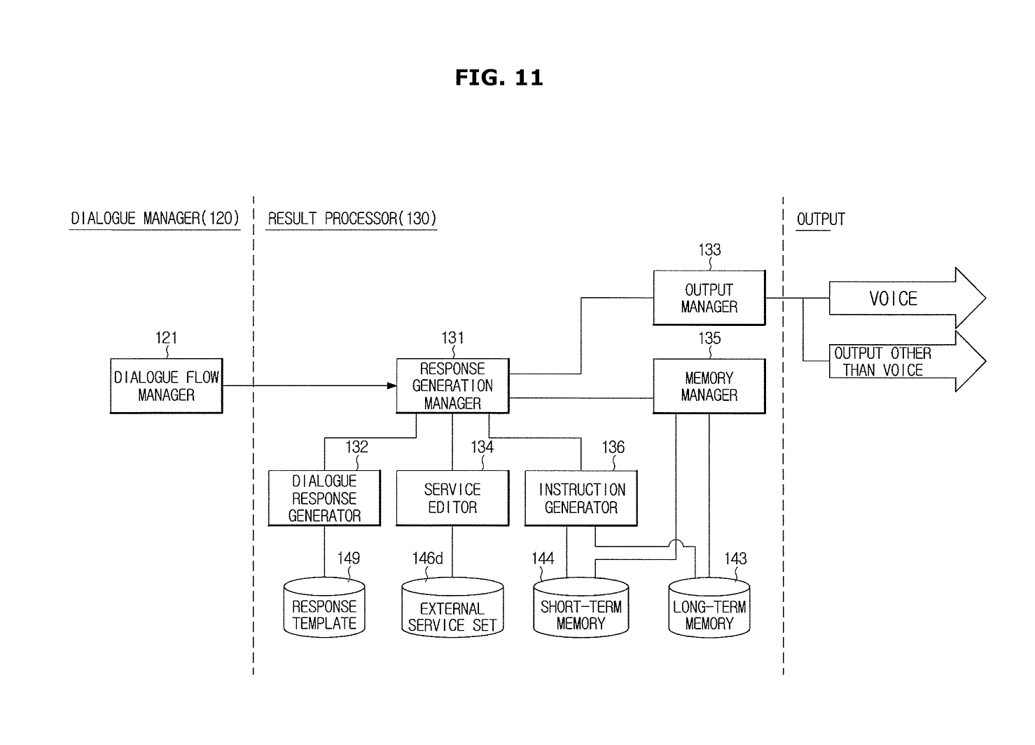

FIG. 11 is a detailed control block diagram of a result processor according to exemplary embodiments of the present disclosure. Referring to FIG. 11, the result processor 130 includes a response generation manager 131 configured to manage generation of a response necessary to execute an action input from the dialogue manager 120; an dialogue response generator 132 configured to generate a text response, an image response, or an audio response according to a request from the response generation manager 131; an instruction generator 136 configured to generate an instruction for controlling a vehicle or an instruction for providing a service using external content according to a request from the response generation manager 131; a service editor 134 configured to sequentially or sporadically execute a plurality of services to provide a service desired by a user and then collect results of the execution; an output manager 133 configured to output the generated text response, image response, or audio response or output the instruction generated by the instruction generator 136 and determine an output order when there are a plurality of outputs; and a memory manager 135 configured to manage the long-term memory 143 and the short-term memory 144 on the basis of the outputs of the response generation manager 131 and the output manager 133.

The result processor 130 may include a memory configured to store a program for performing the above-described operation or the following operation and a processor configured to execute the stored program. At least one memory and at least one processor may be provided. When a plurality of memories or processors is provided, the memories or processors may be integrated on a single chip and may be physically separated from each other.

Also, the elements included in the result processor 130 may be implemented using a single processor or using separate processors. The result processor 130, the dialogue manager 120, and the input processor 110 may be implemented using a single processor or using separate processors.

An output response corresponding to a user's utterance or a vehicle's driving situation may include dialogue response, vehicle control, external content provision, etc.

The dialogue response may have a format such as an initial dialogue, a query, and a reply including a provision of information, and a database of the dialogue response may be built and stored in a response template 149.

For example, when a user inputs a detailed utterance about accident information, the result processor 130 may output a reply indicating that the user's intent has been determined.

In association with the vehicle control, the result processor 130 may deliver classified accident information such as a detailed accident scale or accident time that is input by the user to the AVN device 250 or the accident information processing client 290.

In association with the external content provision, the result processor 130 may deliver the classified accident information to the external accident information processing server 310 or the external server 400. Thus, it is possible to increase the accuracy of accident information.

The response generation manager 131 requests the dialogue response generator 132 and the instruction generator 136 to generate a response necessary to perform an action determined by the dialogue manager 120. To this end, the response generation manager 131 may transmit information regarding an action to be executed to the dialogue response generator 132 and the instruction generator 136. The information regarding an action to be executed may include an action name, a factor value, etc. When the response is generated, the dialogue response generator 132 and the instruction generator 136 may refer to a current dialogue state and a current action state.

The dialogue response generator 132 may search the response template 149 to extract a dialogue response form and may fill a necessary factor value in the extracted dialogue response form to generate a dialogue response. The generated dialogue response is delivered to the response generation manager 131. When the factor value necessary to generate the dialogue response is not delivered from the dialogue manager 120 or when an instruction to use external content is delivered, the dialogue response generator 132 may receive the necessary factor value from the external content server 400 or search the long-term memory 143, the short-term memory 144, or the situation information DB 142.

For example, when an action/event determined by the dialogue manager 120 corresponds to an accident information warning, the dialogue response generator 132 may search the response template 149 to extract “There is [accident information:-] [ahead:-]. Do you want to add accident information?” as the dialogue response form.

Among factors to be filled in the dialogue response form, a factor value of accident information may be delivered from the dialogue manager 120, but a factor value of [ahead] may not be delivered. In this case, the dialogue response generator 132 may request the external server 400 to transmit a distance from [current location] to [location of accident information] and a time taken to travel the distance.

When a response to the user's utterance or the situation includes vehicle control or external content provision, the instruction generator 136 may generate an instruction for executing the response. For example, when an action determined by the dialogue manager 120 is classifying the accident information by grade, the instruction generator 136 generates an instruction for executing a corresponding control and delivers the generated instruction to the response generation manager 131.

Alternatively, when an action determined by the dialogue manager 120 is necessary to provide external content, the instruction generator 136 generates an instruction for classifying by grade the accident information from the external accident information processing server 310 and delivers the instruction to the response generation manager 131.

When a plurality of instructions is generated by the instruction generator 136, the service editor 134 determines a method and a sequence of the service editor 134 executing the plurality of instructions and delivers the method and sequence to the response generation manager 131.

The response generation manager 131 delivers the response delivered from the dialogue response generator 132, the instruction generator 136 or the service editor 134 to the output manager 133.

The output manager 133 determines an output timing, an output sequence, an output location, etc. of the dialogue response generated by the dialogue response generator 132 and of the instruction generated by the instruction generator 136.

The output manager 133 transmits the dialogue response generated by the dialogue response generator 132 and the instruction generated by the instruction generator 136 to an appropriate output location in an appropriate sequence with appropriate timing to output a response. A text to speech (TTS) response may be output through a speaker 232, and a text response may be output through a display 231. When the dialogue response is output in the form of TTS, a TTX module provided in the vehicle 200 may be used or the output manager 133 may include a TTX module.

Depending on an object to be controlled, the instruction may be transmitted to the vehicle controller 240 or may be transmitted to the communication device 280 to communicate with the external server 400.

The response generation manager 131 may deliver the response delivered from the dialogue response generator 132, the instruction generator 136 or the service editor 134 to the memory manager 135.

Also, the output manager 133 may deliver the response output by the output manager 133 to the memory manager 135. The memory manager 135 manages the long-term memory 143 and the short-term memory on the basis of content delivered from the response generation manager 131 and the output manager 133. For example, the memory manager 135 may update the short-term memory 144 by storing a dialogue between a user and a system on the basis of the generated or output dialogue response and may update the long-term memory 143 by storing user-related information acquired through dialogue with a user.

Further, among the information stored in the short-term memory 144, the memory manager 135 may store meaningful and permanent information such as a user's disposition or preference or information capable of being used to acquire the meaningful and permanent information in long-term memory 143.

The memory manager 135 may update a user preference or a vehicle control history stored in the long-term memory 143 on the basis of a vehicle control or an external content request corresponding to the generated and output instruction.

According to the above-described dialogue system 100, it is possible to provide an optimal service needed by a user in consideration of various situations that occur in a vehicle.

In particular, when vehicle driving information is input in addition to the accident information, the dialogue system 100 may request a user to input additional accident information, and the user may transmit a specific scale or time as a response in addition to registration/deregistration of the accident information confirmed by the user. When such an utterance is input, the dialogue system 100 may classify accident information by grade, deliver the accident information to the vehicle controller 240 or the external server 400 and share the accident information with other vehicles.

Also, when the user inputs an utterance for expressing an emotion that is felt when the user views an accident scene, the dialogue system 100 cannot extract a specific domain or action from the user's utterance, but may determine the user's intent and conduct a dialogue using surrounding situation information, vehicle state information, user state information, etc. The above example may be performed by the ambiguity resolver 123 resolving ambiguity of the user's utterance as described above.

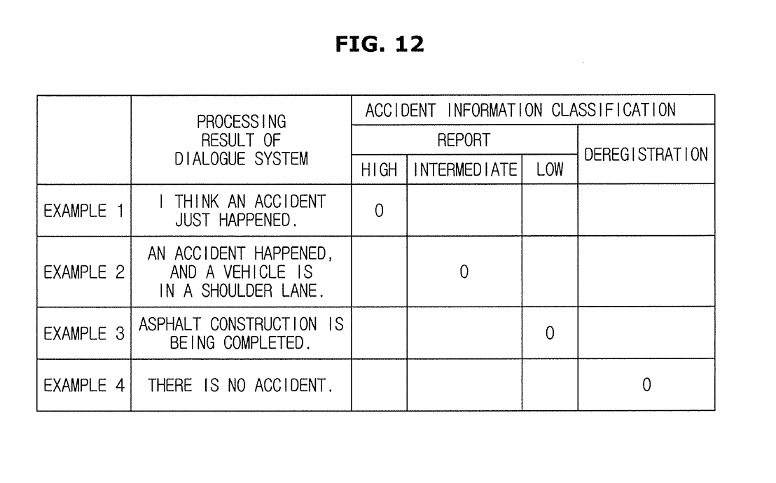

FIG. 12 is a diagram illustrating classification by grade for accident information output by a dialogue system according to exemplary embodiments of the present disclosure.

Referring to FIG. 12, a user may answer a question as to whether to register accident information of the dialogue system 100 as Examples 1 to 4.

In detail, like Example 1, the user may make a response “I think an accident just happened.” Here, the dialogue system 100 may determine that the user reports accident information through an utterance such as in Example 1.

In detail, the input processor 110 extracts factor values for classifying the accident information by grade from the words or phrases “accident” and “I think.” The extracted factor values are delivered to the dialogue manager 120, and the dialogue manager 120 classifies an accident by grade.

Like in Example 1, the accident information indicates that an accident just happened, and the accident may cause traffic congestion. Accordingly, the accident information is set to have a high grade. In FIG. 12, the grade may correspond to “high.”

Example 2 shows a case in which a user makes a response “There is an accident, and a vehicle is in a shoulder lane.” The dialogue system 100 may predict, through the user's utterance, that traffic congestion will be resolved because accident handling is already being conducted and the accident vehicle is moved on the shoulder lane. In this case, the grade of the accident information may correspond to “intermediate.”

Like Example 3, a user may report that “Asphalt construction is being completed.” The asphalt construction may lead to traffic congestion, but may not be a sudden accident leading to severe congestion. Accordingly, the dialogue system 100 may classify the accident information as “low” grade.

In Example 4, the dialogue system 100 may induce a user to provide accident information and may determine that the accident information is incorrect as a result of the user's confirmation. In this case, the user may make an utterance “there is no accident.” In this case, the dialogue system 100 may deregister the accident information.

Thus, the dialogue system 100 may analyze the user's utterance, obtain specific information of the accident information and classify the accident information.

Thus, the disclosed dialogue system 100 and accident information processing system 300 can provide a detailed and accurate service to other vehicles or during subsequent driving guidance by inducing participation of a user, receiving a real-time accident processing status, and classifying the processing status beyond the conventional way in which the AVN device 250 guides a user's driving route using only simple accident information.

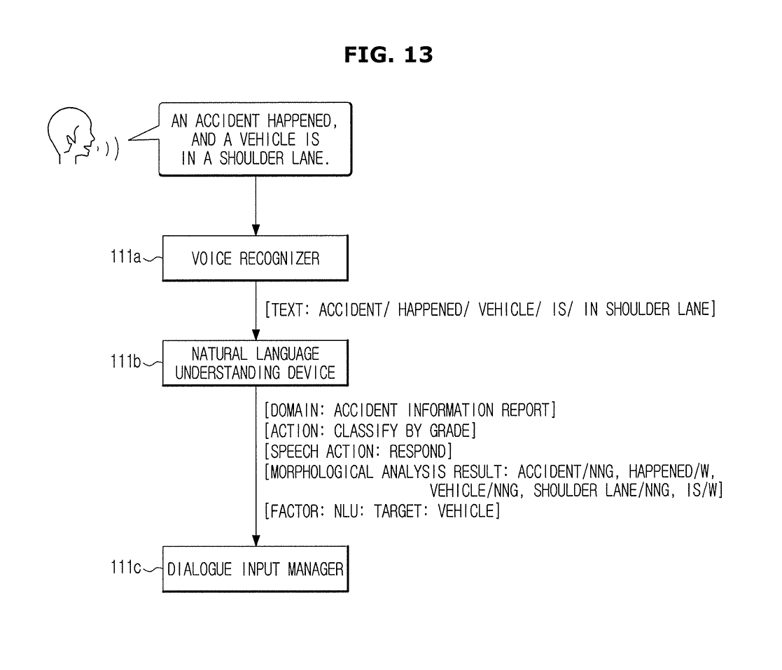

FIGS. 13 to 15 are diagrams illustrating a detailed example of recognizing a user's utterance and classifying accident information as shown in FIG. 12 according to exemplary embodiments of the present disclosure.

As shown in FIG. 13, when a user inputs an utterance “An accident happened, and a vehicle is in a shoulder lane,” the voice recognizer 111a outputs the user's voice in the form of a text-type utterance sentence.

The natural language understanding device 111b may perform a morphological analysis, extract [domain: accident information report], [action: classify by grade], [speech action: respond], and [factor: NLU: target: vehicle] from a result of the morphological analysis (accident/NNG, happened/VV, vehicle/NNP, is/VV), and input the extracted result to the dialogue input manager 111c.

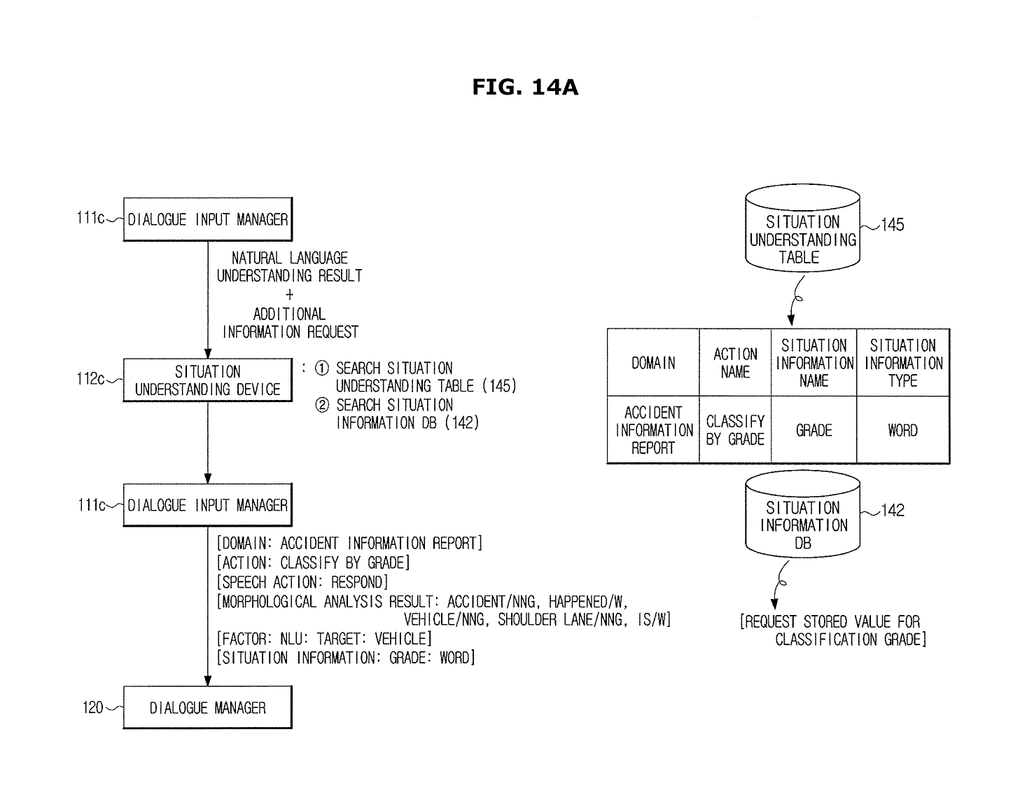

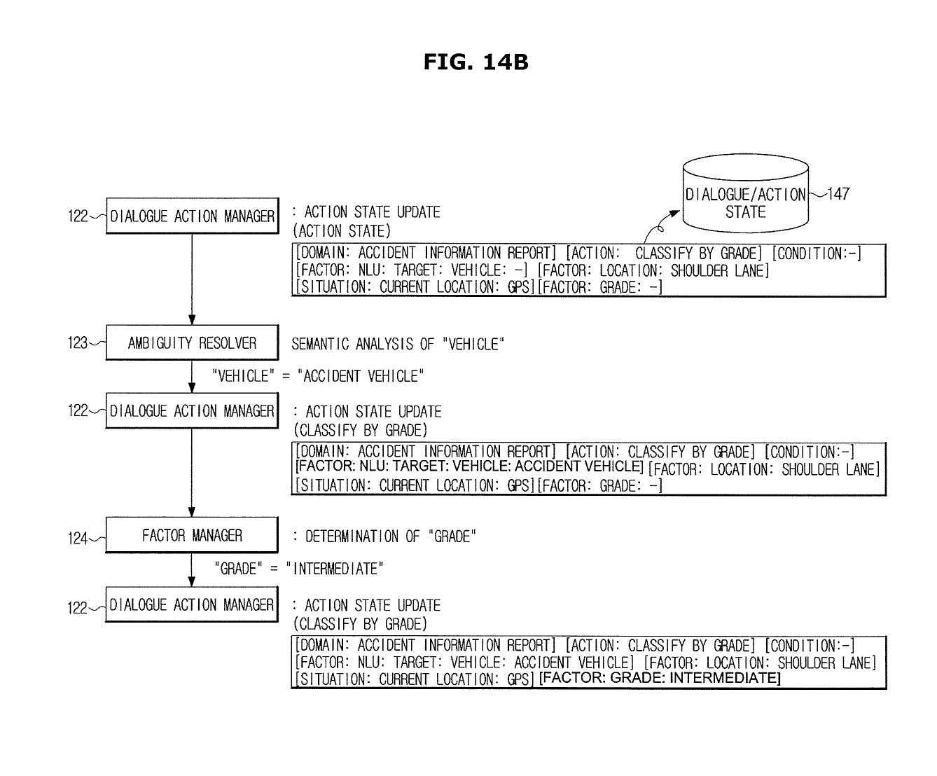

Referring to FIG. 14A, the dialogue input manager 111c requests the situation understanding device 112c to send additional information to the dialogue input manager 111c while the dialogue input manager 111c delivers the natural language understanding result of the natural language understanding device 111b to the situation understanding device 112c.

For example, the situation understanding device 112c may search the situation understanding table 145 to extract that the situation information associated with [domain: accident information report] and [action: classify by grade] is “grade” and also extract that the situation information type is “character.”

The situation understanding device 112c searches the situation information DB 142 to extract a grade-related word “high,” “intermediate,” or “low.” When the grade-related word for the accident information is not stored in the situation information DB 142, the situation understanding device 112c requests the situation information collection manager 112b to send stored classification grade to the situation understanding device 112c.

The situation information collection manager 112b instructs the situation information collector 112a to collect grade information necessary to classify the accident information by sending a signal to the situation information collector 112a. The situation information collector 112a collects information necessary for grade information from the vehicle controller 240, the AVN device 250, and the communication device 280, stores the necessary information in the situation information DB 142, and transmits the necessary information to the situation information collection manager 112b. When the situation information collection manager 112b delivers a collection acknowledgement signal to the situation understanding device 112c, the situation understanding device 112c delivers the information collected from the situation information DB 142 to the dialogue input manager 111c.

The dialogue input manager 111c integrates the natural understanding results [domain: accident information report], [action: classify by grade], [speech action: respond], [factor: NLU: target: vehicle] [situation information: grade: word] and delivers the integrated results to the dialogue manager 120.

Referring to FIG. 14B, the dialogue action manager 122 of the dialogue manager 120 requests the factor manager 124 to send a factor list used to perform each candidate action to the dialogue action manager 122.

In order to acquire factor values corresponding to an essential factor and an optional factor of each candidate action, the factor manager 124 searches the dialogue/action state DB 147, the situation information DB 142, the long-term memory 143, and the short-term memory 144 for a corresponding factor value at a reference location for each factor. When the factor value needs to be provided through an external service, the factor manager 124 may request the needed factor value from the external content server 400 through external information manager 126.

From an action factor 146a, the factor manager 124 may extract a target, a location, and a grade as essential factors used to execute a classification by grade action and may extract a current location (GPS) as an optional factor.

The extracted factor list may be delivered to the dialogue action manager 122 and may be used to update the action state.

The ambiguity resolver 123 may check whether there is ambiguity in converting [factor: NLU: target: vehicle] into a factor appropriate for classification by grade. The “vehicle” may refer to an accident vehicle and may refer to a vehicle being driven by the user.

The ambiguity resolver 123 confirms that there is a modifier related to the vehicle during the user's utterance with reference to a morphological analysis result. The ambiguity resolver 123 searches the long-term memory 143 and the short-term memory 144 for a schedule, a location, a contact etc.

For example, the ambiguity resolver 123 may determine that the “vehicle” is the “accident vehicle” on the basis of an accident information report of a domain, a location of the shoulder lane and a current location of the vehicle 200.

The ambiguity resolver 123 delivers the acquired information to the dialogue action manager 122, and the dialogue action manager 122 updates an action state by adding “[factor: NLU: target: accident vehicle]” to the action state as a factor value.

Also, the dialogue action manager 122 may classify the accident information by grade on the basis of the updated action state. The grade of the action information is determined on the basis of information on classification by grade collected through the situation understanding device 112c.

In detail, the dialogue action manager 122 may search the collected data from a factor “accident vehicle” and a factor “shoulder lane” and may determine that the accident information is “intermediate” through a classification criterion, as shown in FIG. 12.

In this case, the dialogue action manager 122 updates the action state by adding “[factor: grade: intermediate]” to the factors.

Meanwhile, the disclosed factor value is not limited to information necessary to resolve the above-described ambiguity. The factor value includes any data necessary to determine the grade of the accident information. In detail, the factor value may include various data such as an accident time, a traffic flow, a degree to which an accident vehicle is damaged and the number of accident vehicles.

Also, when a factor value necessary to classify the accident information by grade is not extracted from the user's utterance, the dialogue action manager 122 may acquire a factor value needed for situation information collected by the vehicle controller 240 and the input-except-voice device 220.

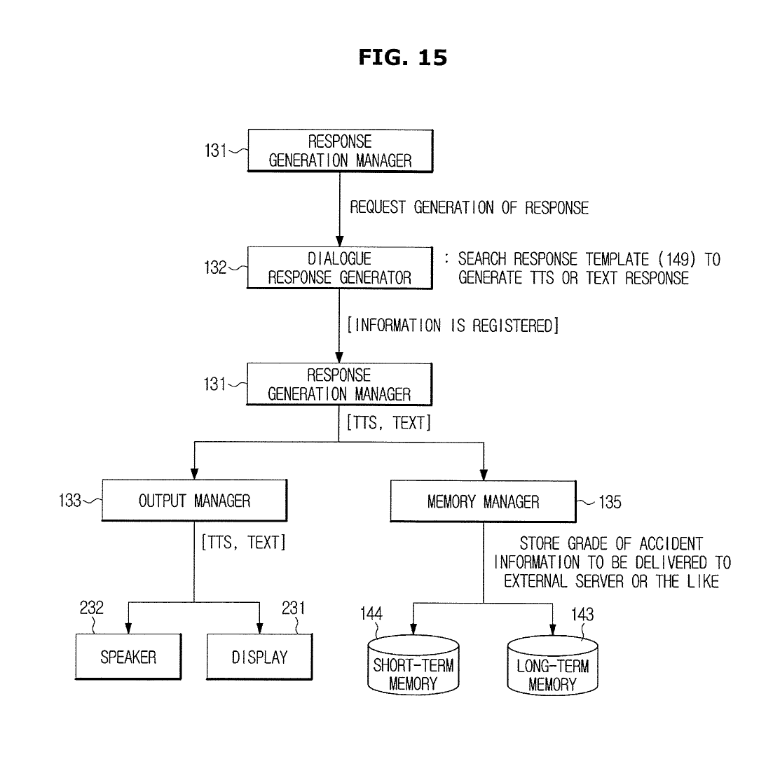

Referring to FIG. 15, the response generation manager 131 requests the dialogue response generator 132 to generate a response according to a request from the dialogue flow manager 121.

The dialogue response generator 132 searches the response template 149 and generates a TTS response and a text response. For example, the dialogue response generator 132 may generate a dialogue response that may be output in the form of TTS or text.

The response generation manager 131 delivers a TTS response and a text response generated by the dialogue response generator 132 to the output manager 133 and the memory manager 135. The output manager transmits the TTS response to the speaker 232 and transmits the text response to the display 231. In this case, the output manager 133 may transmit the TTS response to the speaker 232 through a TTS module configured to convert the text into voice.

The memory manager 135 may store information indicating that the user has responded to the accident information in the short-term memory 144 or the long-term memory 143.

The response generation manager 131 delivers the generated dialogue response and instruction to the output manager 133. The output manager 133 may output the dialogue response through the display 231 and the speaker 232, and may transmit the grade of the accident information to the AVN device 250 of the vehicle 200 through the vehicle controller 240, through an external server 400 configured to provide a navigation server or the like.

As an example, the memory manager 135 may induce participation of a user by counting the number of times the user responds to the accident information and providing points or rewards to the user. The memory manager 135 determines that a user with a high amount of points has high response reliability and may additionally transmit reliability-related data when sending data outside of the vehicle regarding the grade of the accident information.

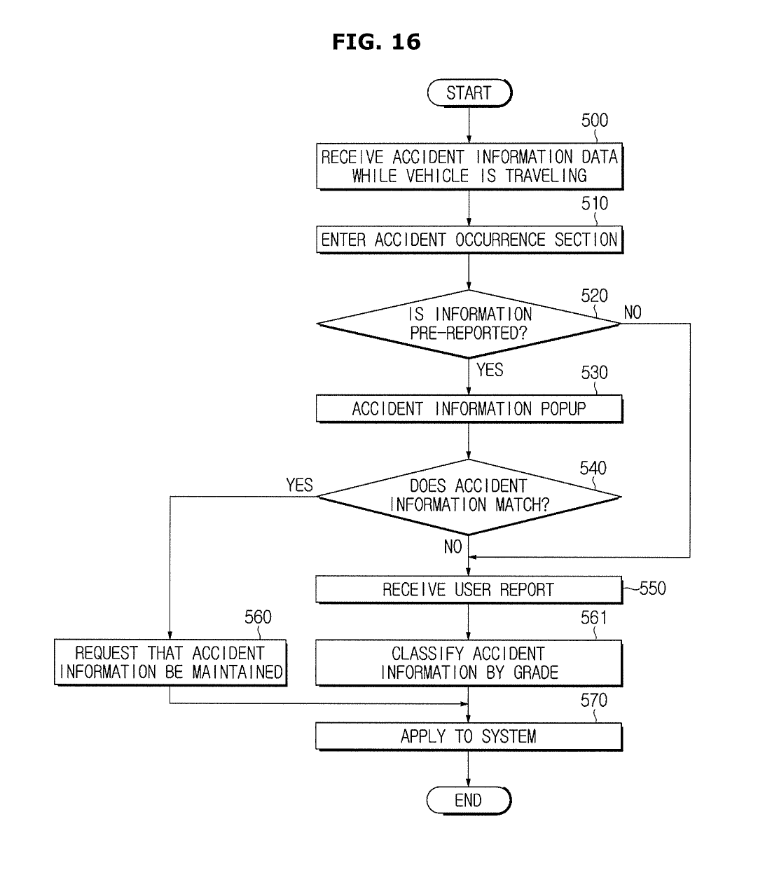

FIG. 16 is a flowchart showing a method of classifying accident information by grade performed by a vehicle including a dialogue system according to exemplary embodiments of the present disclosure.

First, an AVN device 250 receives data regarding accident information about an accident on a driving route while a user is driving a vehicle 200 (500). The AVN device 250 may determine that the vehicle 200 has just entered an area where an accident occurred on the basis of GPS data or the like (510). In detail, information determined by the AVN device 250 is driving environment information (situation information) and is delivered to an input processor 110 of a dialogue system 100.

On the basis of the driving environment information, the dialogue system 100 may utter a question for inducing the user to participate in classification of the accident information by grade. In detail, the dialogue system 100 may determine whether the accident information needs to be classified by grade through the situation understanding device 112c and may determine a question stored in a dialogue policy 148. Subsequently, a result processor 130 utters a question through a speaker 232.

Through such a question, the user may input a report for the accident information to the input processor 110. The dialogue system 100, particularly a dialogue flow manager 121, may determine whether the user's report is pre-reported information (520).

In detail, the accident information may be collected through several vehicles on a road. Accordingly, the accident information reported by the user of the vehicle 200 may be the same as information pre-reported by users of other vehicles.

Here, the pre-reported information may be prestored in the AVN device 250 or may include a specific accident scale and accident time of the accident collected in addition to the accident information from an external server 400 or the like. When the accident information reported by the user matches the pre-reported information, the dialogue system 100 causes accident information popup to appear (530).

Subsequently, the dialogue system 100 may ask the user whether the accident information popup matches the accident information reported by the user. As an example, the dialogue system 100 may output a request “Does the reported accident information match the accident information popup?”

When a voice or an output other than voice indicating that the reported accident information matches the accident information popup is received from the user, the dialogue system 100 requests that the accident information be maintained (560). The AVN device 250 or the like applies the accident information to an accident information processing system 300 in response to a maintenance request signal from the dialogue system 100 (570).

As a non-limiting example, the user's participation applied to the accident information processing system 300 additionally includes information such as point information, and the information may be used to secure reliability of the user's participation and increase accuracy of information processing.

Meanwhile, when the dialogue system 100 determines that the report of the user is not the pre-reported information, the dialogue system 100 receives the report of the user (550).

The accident information reported by the user may be varied and is not limited.

The dialogue system 100 may analyze the user's input utterance to acquire the accident information, resolve ambiguity or the like and classify the accident information by grade (561).

During a process of classification by grade, the dialogue system 100 may classify by grade using various data stored in a vehicle controller 240 and an external accident information processing system 300 in addition to a storage 140.

According to the disclosed embodiments, there are no limitations when the user utters the accident information and the dialogue system 100 classifies the accident information by grade. In detail, the dialogue system 100 classifies the accident information and then stores the classified accident information in the storage 140. Subsequently, the dialogue system 100 or the AVN device 250, having received the classified accident information, may change the grade from “high” to “low” over time and adjust the classification grade in consideration of the grade of the accident information delivered from outside, such as from other vehicles.

Also, after the classification by grade, the dialogue system 100 may output a voice indicating that the classification by grade has been performed and points are given to the user through a result processor 130.

The classification grade by the dialogue system 100 is applied to the accident information processing system 300 (570).

Thus, according to the disclosed dialogue system 100 and the vehicle 200 including the same, it is possible to increase accuracy of accident information and help the user adjust a driving route and safely drive using the accident information by improving conventional navigation guidance, the conventional navigation guidance being performed by only determining whether accident information is present and whether accident information is to be deregistered.

As is apparent from the above description, the dialogue system, the vehicle including the same, and the accident information processing method according to an aspect can specifically determine the presence, deregistration, and severity of accident information, perform real-time updates on a navigation system, provide accurate route guidance to a driver, and make it possible for a driver to drive safely by acquiring accident information confirmable by a user through dialogue while the vehicle is traveling.

Although some embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A dialogue system, comprising:
an input processor for receiving accident information and extracting an action corresponding to a user's speech, wherein the corresponding action is an action of classifying the accident information by grade;
a storage for storing vehicle situation information including the accident information and grades associated with the accident information;
a dialogue manager for determining the grade of the accident information on the basis of the vehicle situation information and the user's speech; and
a result processor for generating a response associated with the determined grade and delivering the determined grade of the accident information to an accident information processing system.

2. The dialogue system of claim 1, wherein the input processor extracts a factor value for determining the grade of the accident information from the user's speech.

3. The dialogue system of claim 2, wherein the dialogue manager determines the grade of the accident information on the basis of a factor value delivered by the input processor and a determination criterion stored by the storage.

4. The dialogue system of claim 1, wherein the dialogue manager determines a dialogue policy regarding the determined grade of the accident information, and
wherein the result processor outputs a response including the classification grade of the accident information.

5. The dialogue system of claim 1, wherein when the input processor does not extract the factor value for determining the grade of the accident information, the dialogue manager acquires the factor value from the storage.

6. The dialogue system of claim 2, wherein the factor value includes at least one of an accident time, a traffic flow, a degree to which an accident vehicle is damaged and a number of accident vehicles.

7. The dialogue system of claim 1, wherein the result processor generates a point acquisition response based on the determined classification grade of the accident information.

8. The dialogue system of claim 1, wherein the dialogue manager changes the classification grade over time and stores the changed grade in the storage.

9. A vehicle, comprising:
an audio-video-navigation (AVN) device for setting a driving route and executing navigation guidance on the basis of the driving route;
an input processor for receiving accident information from the AVN device and extract an action corresponding to a user's speech, wherein the corresponding action is an action of classifying the accident information by grade;
a storage for storing vehicle situation information including the accident information and grades associated with the accident information;
a dialogue manager for determining the grade of the accident information on the basis of the vehicle situation information and the user's speech; and
a result processor for generating a response associated with the determined grade and deliver the determined grade of the accident information to the AVN device.

10. The vehicle of claim 9, wherein the AVN device executes the navigation guidance on the basis of the determined grade of the accident information delivered from the result processor.

11. The vehicle of claim 9, further comprising a communication device for communicating with an external server,
wherein the communication device receives the accident information and delivers the accident information to at least one of the AVN device and the external server.

12. The vehicle of claim 9, wherein the input processor extracts a factor value for determining the grade of the accident information from the user's speech.

13. The vehicle of claim 12, wherein the dialogue manager determines the grade of the accident information on the basis of a factor value delivered by the input processor and a determination criterion stored by the storage.

14. The vehicle of claim 11, wherein when the accident information is pre-reported accident information, the dialogue manager requests that the accident information be maintained through the communication device.

15. The vehicle of claim 11, wherein the dialogue manager delivers the determined grade of the accident information and reliability of the accident information to an external source through the communication device.

16. The vehicle of claim 11, further comprising a camera for capturing the user and an outside of the vehicle,
wherein when a factor value of an action factor necessary to determine the grade of the accident information is not extracted, the dialogue manager extracts the factor value on the basis of situation information acquired by the camera.

17. A method of classifying accident information by grade, the method comprising:
receiving the accident information and extracting an action corresponding to a user's speech, wherein the corresponding action is an action of classifying the accident information by grade;
storing an information value of vehicle situation information including the accident information and grades associated with the accident information;
determining the grade of the accident information on the basis of the stored information value of the vehicle situation information and the user's speech;
generating a response associated with the determined grade; and
delivering the determined grade of the accident information to an accident information processing system.

18. The method of claim 17, wherein the extraction comprises extracting a factor value for determining the grade of the accident information from the user's speech.

19. The method of claim 17, wherein the determination comprises determining a dialogue policy regarding the grade of the accident information.

20. The method of claim 17, further comprising:
receiving the information value of the vehicle situation information from a mobile device connected to the vehicle; and
transmitting the response to the mobile device.
